(19) United States
(12) Patent Application Publication
(10) Pub. No.: US 2009/0292812 A1
(43) Pub. Date: Nov. 26, 2009

(54) ALLOCATING MANAGEMENT METHOD OF COMPUTER

(76) Inventors: Shigeru Ishida, Yokohama (JP); Shuichi Nemoto, Hadano (JP)

Correspondence Address: BRUNDIDGE & STANGER, P.C., 1700 DIAGONAL ROAD, SUITE 330, ALEXANDRIA, VA, 22314, US

(21) Appl. No.: 12/512,264

(22) Filed: Jul. 30, 2009

Related U.S. Application Data
(63) Continuation of application No. 11/412,966, filed on Apr. 28, 2006.

(30) Foreign Application Priority Data
Dec. 1, 2005 (JP) 2005-347930

(51) Int. Cl. G06F 15/173; G06F 15/16

(52) U.S. Cl. 709/226; 709/223

(57) ABSTRACT

A blade management server is provided for managing the allocation of blade PCs to remote operating terminals, respectively. The blade management server responds to a request for alternative from the remote operating terminal to search for any one of the blade PCs that is not allocated yet, and notify the remote operating terminal of the address of the found blade PC. The remote operating terminal, when receiving the address, changes the blade PC to be connected to itself from the current “statically allocated” blade PC to the blade PC of the address notified of from the blade management server (the “alternatively allocated” blade PC).

### CROSS-REFERENCE TO RELATED APPLICATIONS

The present application is a continuation of application Ser. No. 11/412,966, filed Apr. 28, 2006; which claims priority from Japanese application JP2005-347930 filed on Dec. 1, 2005, the content of which is hereby incorporated by reference into this application.

### BACKGROUND OF THE INVENTION

The present invention relates to an information processing system having a plurality of information processors and operating terminals connected over a network, and particularly to a technique for allocating the information processors to the operating terminals.

JP-A-2001-069145 discloses a standby apparatus management system for managing standby apparatus on a computer network. This standby apparatus management system has a plurality of workstations that execute at least one of a standby apparatus maintenance program, a fault-time standby apparatus arrangement program and a standby apparatus holding-number management program, and a common database server that executes a common database that contains information of standby apparatus. Each program is executed on the workstations if necessary, so that the information of standby apparatus stored in the common database can be searched for, added and deleted, thus the standby apparatus being managed on the computer network.

### SUMMARY OF THE INVENTION

Recently, a so-called thin client type information processing system has attracted attention. In the thin client type information processing system, a remote machine on hand is used to remotely operate a local machine, or desktop computer placed at home or in a company, so that the user can utilize various different application programs and data installed in the local machine. The local machine other than the desktop PC (Personal Computer) may be a blade PC (blade computer) that has no input/output unit (keyboard, mouse and display) locally connected.

This thin client type information processing system may use the technique described in JP-A-2001-069145 in order to manage the standby apparatus as local machines. However, the technique described in JP-A-2001-069145 does not consider the time taken for the operation of changing from the working apparatus to a standby apparatus. The service would be suspended during a long time until the end of the replacement to the standby apparatus.

The present invention provides a management server that manages allocation of a plurality of information processors to operating terminals respectively. The management server responds to a request for alternative from any one of the operating terminals to search for one of the information processors that is not allocated yet, and to notify the operating terminal of the address of the found information processor. The operating terminal replaces the current information processor with the allocated processor of which the address is informed of from the management server.

According to the invention, there is provided, for example, an information processing system having a plurality of information processors, a management server and operating terminals all connected to a network, wherein

the management server has:

an allocation status storage that stores user IDs of users to which the information processors are respectively allocated;

an allocation manager that responds to a request for alternative containing any one of the user IDs to search for any one of the information processors that is not made associated with any one of the user IDs by referring to the allocation status storage and to make the found information processor be associated with the user ID contained in the request for alternative; and

an address informer that responds to the request for alternative to notify a request source of the address of the information processor found by the allocation manager, the operating terminal has:

an address acquiring unit that transmits the request for alternative containing the user ID to the management server and acquires the address of the information processor from the management server; and

a remote operation unit that transmits operation information entered through an input unit of its own operating terminal to the information processor of which the address has been acquired by the address acquiring unit, receives video information from the information processor and makes it be displayed on a display device of its own operating terminal; and

the information processor has:

a remote operation receiver that receives the operation information from the operating terminal, processes the operation information according to its operation content, and transmits the video information indicative of the processed result to the operating terminal.

Thus, according to the invention, the management server responds to the request for alternative from the operating terminal to search for the information processor that is not allocated yet, and notifies the operating terminal of its address, while the operating terminal changes the information processor to be allocated to this terminal from the current processor to the processor of which the address has been notified of from the management server.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram showing an example of the construction of a remote desktop system to which one embodiment of the invention is applied.

FIG. 2 is a block diagram showing an example of the construction of a blade PC 1.

FIG. 3 is a flowchart to which reference is made in explaining an example of the operation of the blade PC 1.

FIG. 4 is a block diagram showing an example of the construction of a blade management server 7.

FIG. 5 is a diagram showing an example of an allocation status management table 7042.

FIG. 6 is a diagram showing an example of an operation status management table 7043.

FIG. 7 is a flowchart to which reference is made in explaining an example of the operation of the blade management server 7.

FIG. 8 is a flowchart useful for explaining an example of step S201 (connection process) of FIG. 7.

FIG. 9 is a flowchart useful for explaining an example of step 211 (disconnection process) of FIG. 7.

FIG. 10 is a flowchart useful for explaining an example of step S211 (alternative process) of FIG. 7.

FIG. 11 is a flowchart useful for explaining an example of step S231 (return process) of FIG. 7.

FIG. 12 is a flowchart useful for explaining an example of step S241 (reflection process) of FIG. 7.

FIG. 13 is a flowchart useful for explaining an example of step (diagnosis process) of FIG. 7.

FIG. 14 is a block diagram showing an example of the construction of a remote operating terminal 2.

FIG. 15 is a flowchart useful for explaining an example of the operation of the remote operating terminal 2.

FIG. 16 is a diagram useful for explaining an example of the view on remote operating terminal 2.

FIG. 17 is a block diagram showing an example of the construction of an authentication device 6.

FIG. 18 is a flowchart useful for explaining an example of the operation of authentication device 6.

FIG. 19 is a block diagram showing an example of the construction of a user information save server 8.

FIG. 20 is a diagram showing an example of a user data management table 8042.

FIG. 21 is a flowchart useful for explaining an example of the operation of user information save server 8.

FIG. 22 is a diagram showing an example of the operation of the system in the case where the blade PC 1 “statically allocated” to the user is normally operated.

FIG. 23 is a diagram showing an example of the operation of the system in the case where the blade PC 1 “statically allocated” to the user is broken down and thus VPN establishment fails in S607 of FIG. 22.

FIG. 24 is a diagram showing an example of the operation of the system in the case where the blade PC 1 “statically allocated” to the user is completely repaired for its failure, and thus the blade PC 1 “alternatively allocated” to the user with the VPN established in step S628 of FIG. 23 is returned.

### DETAILED DESCRIPTION OF THE EMBODIMENTS

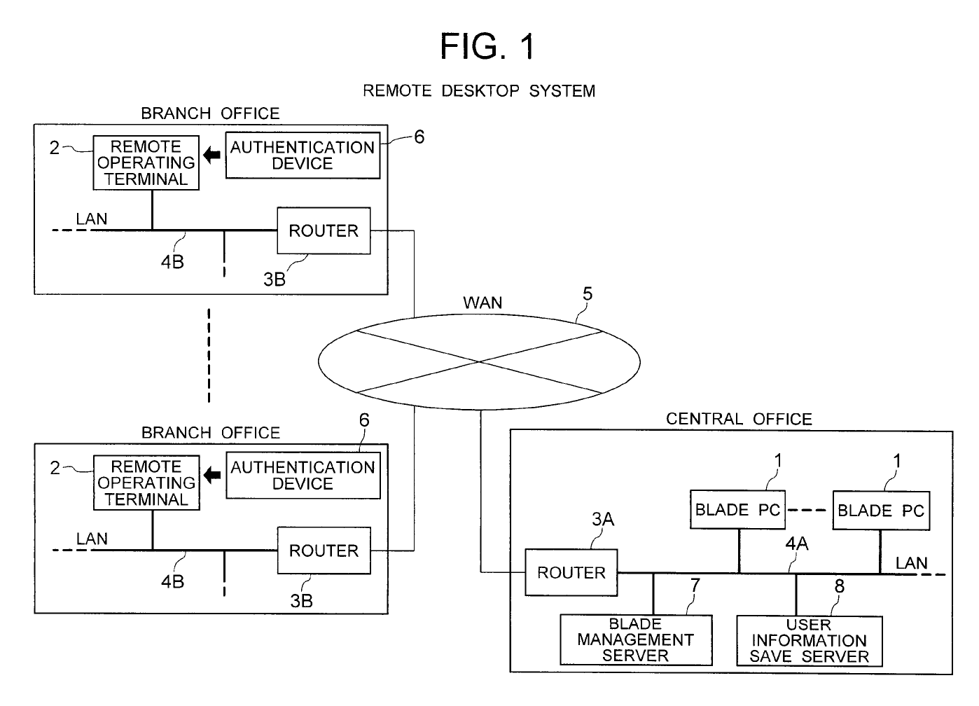

FIG. 1 is a block diagram showing an example of the construction of a remote desktop system (thin client type information processing system).

As illustrated in FIG. 1, the remote desktop system of this embodiment has a plurality of blade PCs (Personal Computers) 1, a plurality of remote operating terminals 2 and authentication devices 6, a blade management server 7 and a user information save server 8.

The plurality of blade PCs 1, the blade management server 7 and the user information save server 8 are connected through a LAN (Local Area Network) 4A built in, for example, the central office of a company. The LAN 4A is connected through a router 3A to a WAN (Wide Area Network) 5.

The authentication device 6 is detachably connected to the remote operating terminal 2. The remote operating terminal 2 is connected to a LAN 4B built in, for example, each branch office of the company. The LAN 4B is connected through a router 3B to the WAN 5.

The blade PC 1 builds up a VPN (Virtual Private Network) between it and any one of the remote operating terminals 2, receives the input information (the operation content entered by an input unit) transmitted from the remote operating terminal 2 through this VPN, and processes the input information. The blade PC 1 then transmits video information (the desktop view on a display device) indicative of the processed result to the remote operating terminal 2.

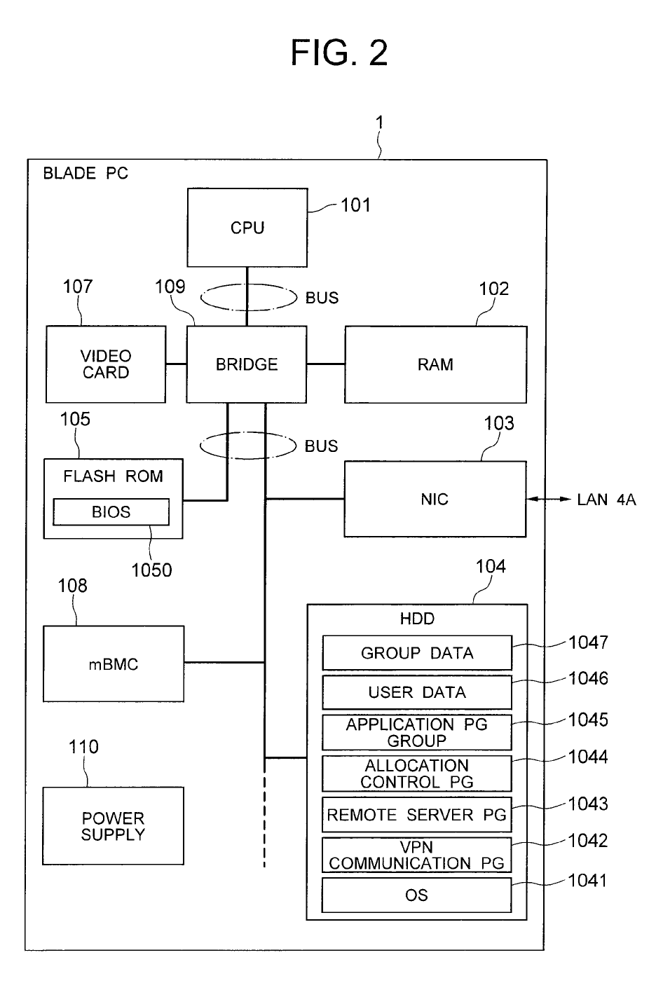

FIG. 2 is a block diagram showing an example of the construction of the blade PC 1. As illustrated, the blade PC 1 has a CPU (Central Processing Unit) 101, a RAM (Random Access Memory) 102 that acts as the work area of CPU 101, a NIC (Network Interface Card) 103 for connecting to LAN 4A, an HDD (Hard Disk Drive) 104, a flash ROM (Read Only Memory) 105, a video card 107 for generating the video information on the desktop, an mBMC (mini-Base board Management Controller) 108, a bridge 109 that relays information on buses BUS that connect these elements 101-108, and a power supply 110.

The flash memory ROM 105 has a BIOS (Basic Input/Output System) 1050 stored therein. The CPU 101, after the power supply 110 is turned on, first makes access to the flash ROM 105, and executes the BIOS 1050, thereby recognizing the system structure of the blade PC 1.

The HDD 104 has at least an OS (Operating System) 1041, a VPN communication program 1042, a remote server program 1043, an allocation control program 1044, a plurality of application programs 1045, user data 1046, and group data 1047 stored therein.

The OS 1041 is the program for the CPU 101 to totally control the elements 102-110 and to execute the programs 1042-1045 as will be described later. The CPU 101 causes the OS 1041 to be loaded from HDD 104 to the RAM 102, and executes the OS according to the BIOS 1050. Thus, the CPU 101 totally controls the elements 102-110 of the blade PC 1.

The VPN communication program 1042 is the communication program that builds up the VPN between the blade PC 1 and the remote operating terminal 2, and that uses, for example, an Ipsec (Security Architecture for the Internet Protocol). Under the control of the OS 1041, the CPU 101 causes the VPN communication program 1042 to be loaded from the HDD 104 to the RAM 102, and executes the program. Thus, the CPU 101 responds to a communication start request from the remote operating terminal 2 via the NIC 103 to build the VPN between the blade PC 1 and the remote operating terminal 2, and makes communication with the remote operating terminal 2 through this VPN.

The remote server program 1043 is the program that enables the remote operating terminal 2 to remotely control the desktop of blade PC 1, and here it is, for example, the server program of VNC (Virtual Network Computing) developed by the AT & T Cambridge Laboratory. Under the control of the OS 1041, the CPU 101 causes the remote server program 1043 to be loaded from the HDD 104 to the RAM 102, and executes the program. Thus, the CPU 101 receives and processes the input information (the operation content resulting from the operation of the keyboard and mouse) sent from the remote operating terminal 2 through the VPN, and transmits the video information (the desktop view on the display) indicative of the processed result to the remote operating terminal 2 through the VPN.

The allocation control program 1044 is the program that causes the user data 1046 and group data 1047 to be uploaded to the user information save server 8 and downloaded from the user information save server 8.

The application programs 1045 include a general-purpose Web browser, a word processor, a CAD, spreadsheet software and so on. The CPU 101, under the control of the OS 1041, responds to an instruction received from the remote operating terminal 2 through the remote server program 1043 to cause a desired one of the application programs 1044 to be loaded from the HDD 104 to the RAM 102 and to execute the program. Then, the CPU 101 forces the video card 107 to produce the video information of the desktop view on which the executed result is reflected, and transmits it to the remote operating terminal 2 through the remote server program 1043.

The user data 1046 is the data that is available on the application programs 1045 and personally used by the user (for example, text data produced on an individual basis). The group data 1047 is the data that is available on the application programs 1045 and used in common on the users of a group to which the user belongs (for example, template).

The mBMC 108 monitors the operation status of blade PC 1, and when the power supply 110 is turned off not to supply power, it causes the NIC 103 to operate by use of another power supply that is provided to separate from the power supply 110. In addition, it notifies the blade management server 7 of the operation status of blade PC 1 in response to the inquiry of the status that is received from the blade management server 7. Moreover, the mBMC 108 turns the power supply 110 on or off according to a control command from the blade management server 7. The mBMC can be operated by the separately provided power supply other than the power supply 110 to the blade PC 1, and thus it can be operated independently even if the power supply to the blade PC 1 is in the off state.

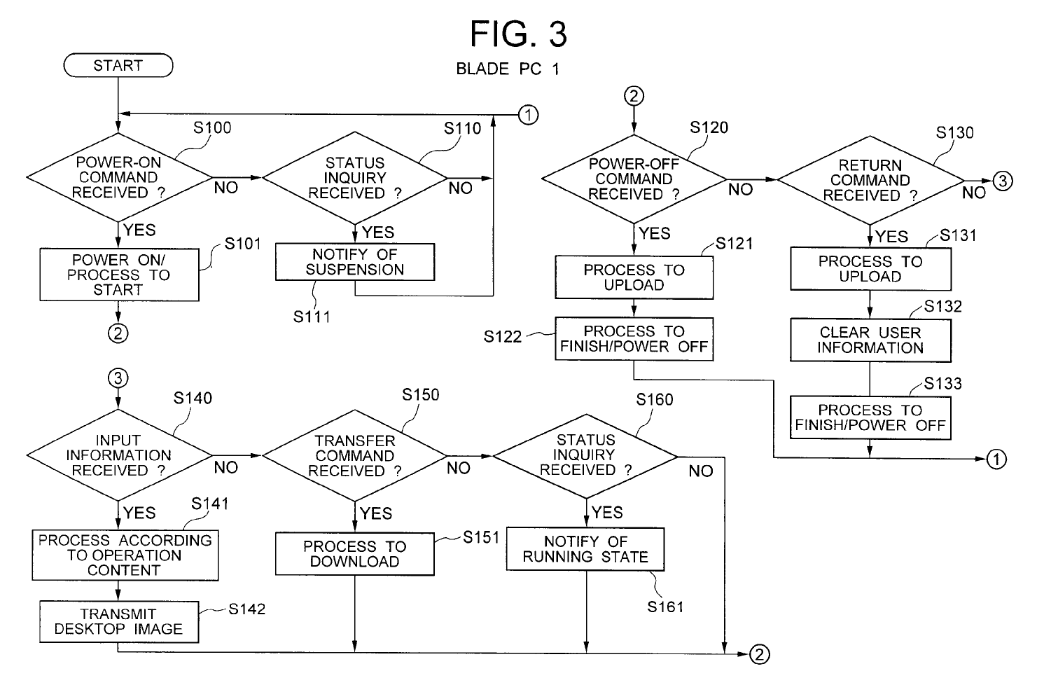

FIG. 3 is a flowchart useful for explaining an example of the operation of blade PC 1. The CPU 101 or mBMC 108 fundamentally executes this flow of processes according to the programs. However, for the convenience of explanation, the programs are assumed here as the main body for executing the flow of processes that are actually executed by the CPU 101.

As described above, the mBMC 108 makes the NIC 103 be operated by other power supply than the power supply 110 for blade PC 1 when the power supply 110 is in the off state. Under this condition, when the mBMC 108 receives the power-on command from the blade management server 7 through NIC 103 (YES in step S100), it turns the power supply 110 on and makes a start process. Specifically, the CPU 101 causes the OS 1041 to be loaded from the HDD 104 to the RAM 102 according to the BIOS 1050. Then, the CPU 101 executes the VPN program 1042 according to the OS 1041 so that a communication channel can be established between the blade PC 1 and a certain remote operating terminal 2, and also executes the remote server program 1043 (S101). Thus, the blade PC 1 operates as a local machine to communicate with this certain remote operating terminal 2 as a remote machine.

In addition, under the condition in which the power supply 110 is in the off state, when the mBMC 108 receives the inquiry of status from the blade management server 7 through the NIC 103 (YES in step S110), it notifies the blade management server 7 of the status information of “suspending” (S111).

Under the condition in which the power supply 110 is in the on state, when the OS 1041 receives the power-off command from the blade management server 7 through the NIC 103 (YES in step S120), it orders the allocation control program 1044 to upload the user data 1046. The allocation control program 1044 is responsive to this order to acquire the user ID of the remote operating terminal (remote machine) 2 from the remote server program 1043, add this user ID to the user data 1046 stored in the HDD 104 and transmit it to the user information save server 8 through the NIC 103 (S121). Then, the OS 1041 forces the various running programs 1042-1045 to be finished, and the power supply 110 to turn off (S122).

In addition, under the condition in which the power supply 110 is in the on state, when the OS 1041 receives the return command from the blade management server 7 through the NIC 103 (YES in step S130), it orders the allocation control program 1044 to upload the user data 1046. The allocation control program 1044 is responsive to this command to acquire the user ID of remote operating terminal (remote machine) 2 from the remote server program 1043, add this user ID to the user data 1046 stored in the HDD 104, and transmit it to the user information save server 8 through the NIC 103 (S131). Then, the OS 1041 erases the user data 1046 from the HDD 104 (S132). Then, the OS 1041 causes the various running programs 1042-1045 to be finished and the power supply 110 to turn off (S133).

Moreover, under the condition in which the power supply 110 is in the on state, when the OS 1041 receives the input information from the remote operating terminal 2 through the NIC 103 (YES in step S140), it sends this input information to a certain active one of the application program 1045. This application program 1045 is responsive to this information to execute processes according to the operation contents (keyboard operation and mouse operation) indicated by this input information (S141). Then, it causes the video card 107 to produce video information indicative of a desktop view on which the processed result is reflected. The OS 1041 transmits this video information to the remote operating terminal 2 through the NIC 103 (S142).

In addition, under the condition in which the power supply 110 is in the on state, when the OS 1041 receives the transfer command with user ID from the blade management server 7 through the NIC 103 (YES in step S150), it orders the allocation control program 1044 to download the user data 1046. Thus, the download request according to the transfer command with user ID is transmitted from the allocation control program 144 to the user information save server 8 via the NIC 103. Thus, the user data 1046 is received from the user information save server 8. Then, the user data 1046 within the HDD 104 is updated with the received user data 1046 (S151).

Furthermore, under the condition in which the power supply 110 is in the on state, when the mBMC 108 receives the status inquiry from the blade management server 7 through the NIC 103 (YES in step S160), it notifies the blade server 7 of the status information indicative of “running” (S161).

Turning back to FIG. 1, the blade management server 7 manages the allocation of a plurality of blades PC 1 to the remote operating terminals 2, respectively.

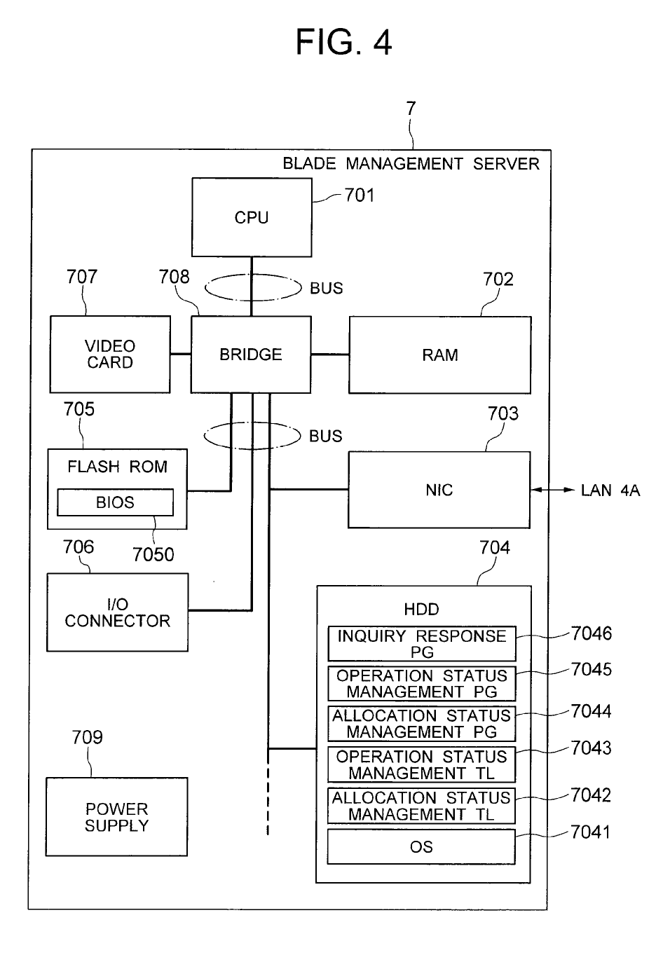

FIG. 4 is a block diagram showing the construction of the blade management server 7. As illustrated, the blade management server 7 has a CPU 701, a RAM 702 that functions as the work area of CPU 701, a NIC 703 for connecting to the LAN 4A, an HDD 704, a flash ROM 705, an I/O connector 706 for connecting the keyboard and the mouse, a video card 707 for connecting the display, a bridge 708 that relays information on the buses BUS for connecting those elements 701-707, and a power supply 709.

The flash ROM 705 has a BIOS 7050 stored therein. The CPU 701 first makes access to the flash ROM 705 after the power supply 709 is turned on, and executes the BIOS 7050, thereby recognizing the system structure of blade management server 7.

The HDD 704 has at least an OS 7041, an allocation status management table 7042, an operation status management table 7043, an allocation status management program 7044, an operation status management program 7045 and inquiry response program 7046 stored therein.

The OS 7041 is the program for the CPU 701 to totally control the elements 702-709 of blade management server 7 to execute each of the programs 7044-7046 which will be described later. The CPU 701 orders the HDD 704 to load the OS 7041 to the RAM 702 and executes it according to the BIOS 7050. Thus, the CPU 701 totally controls the elements 702-709 of blade management server 7.

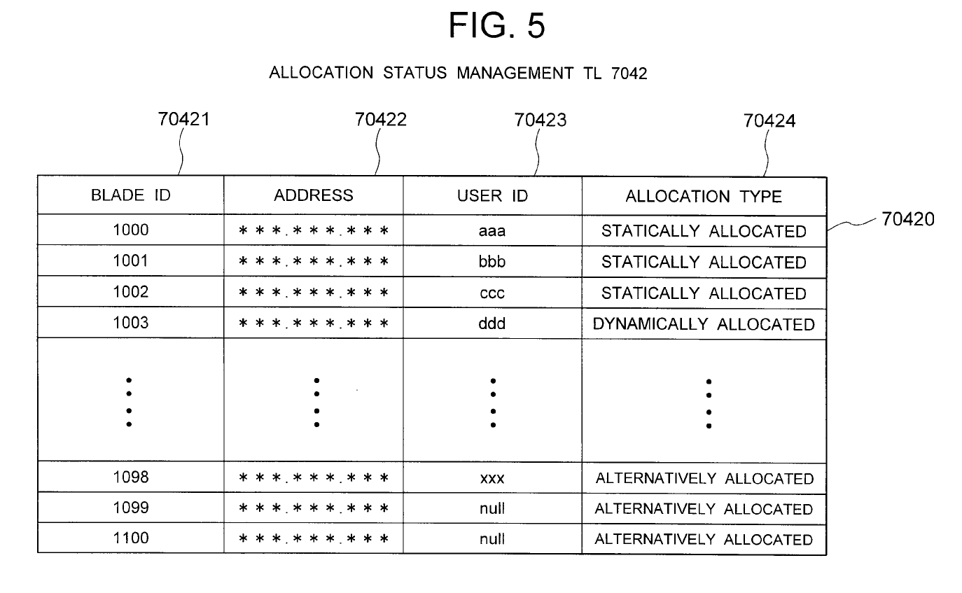

The allocation status management table 7042 has allocation information stored for each corresponding blade PC 1. FIG. 5 shows an example of the allocation management table 7042. As illustrated, a record 70420 is registered for each blade PC 1. The record 70420 has a field 70421 for registering the blade ID as the identification information of blade PC 1, a field 70422 for registering the network address of blade PC 1, a field 70423 for registering the user ID as the user's identification information to which blade PC 1 is allocated, and a field 70424 for registering the type of allocation of blade PC 1. When any ones of the blades PC 1 are not allocated to certain ones of the users yet, null data is registered at the corresponding areas in the field 70423. The types of allocation include “statically allocated” that means the allocation of PCs 1 to users in a fixed manner, “dynamically allocated” that means the allocation of PCs 1 to users at each time of utilization, and “alternatively allocated” that means the allocation of PCs 1 to users on a temporary basis when the blade PC 1 “statically allocated” cannot be used because of its failure or the like.

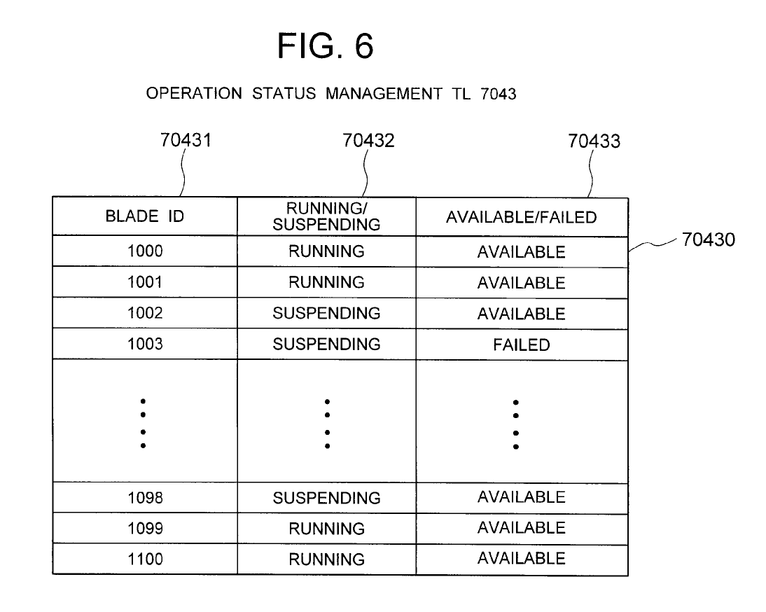

The operation status management table 7043 has stored therein the operation status of each corresponding blade PC 1. FIG. 6 shows an example of the operation status management table 7043. As illustrated, a record 70430 for each blade PC 1 is registered in the table. The record 70430 has a field 70431 for registering the blade ID of each blade PC 1, a field 70432 for registering whether the blade PC 1 is in “running” or “suspending” state, and a field 70433 for registering whether the blade PC 1 is in “available” or “failed” state.

The allocation status management program 7044 is the program that manages the blade PCs 1 to be allocated to the users of remote operating terminals 2, respectively. The allocation status management program 7044 determines the blade PCs 1 to be allocated to the users of remote operating terminals 2 by using the allocation status management table 7042 and operation status management table 7043, and updates the allocation status management table 7042 according to the content of the determination.

The operation status management program 7045 is the program that manages the operation status of blades PC 1. The operation status management program 7045 acquires the operation status of each blade PC 1 and updates the field 70432 of the operation status management table 7043 according to the acquired content. In addition, it updates the field 70433 of the operation status management table 7043 according to the command received from the operator through the keyboard and mouse connected to the I/O connector 706.

The inquiry response program 7046 is the program that responds to the inquiry from the remote operating terminal 2. The inquiry response program 7046 responds to the status inquiry from the remote operating terminal 2 to acquire the operation status of the corresponding blade PC 1 associated with the inquiry, and update the operation status management table 7043.

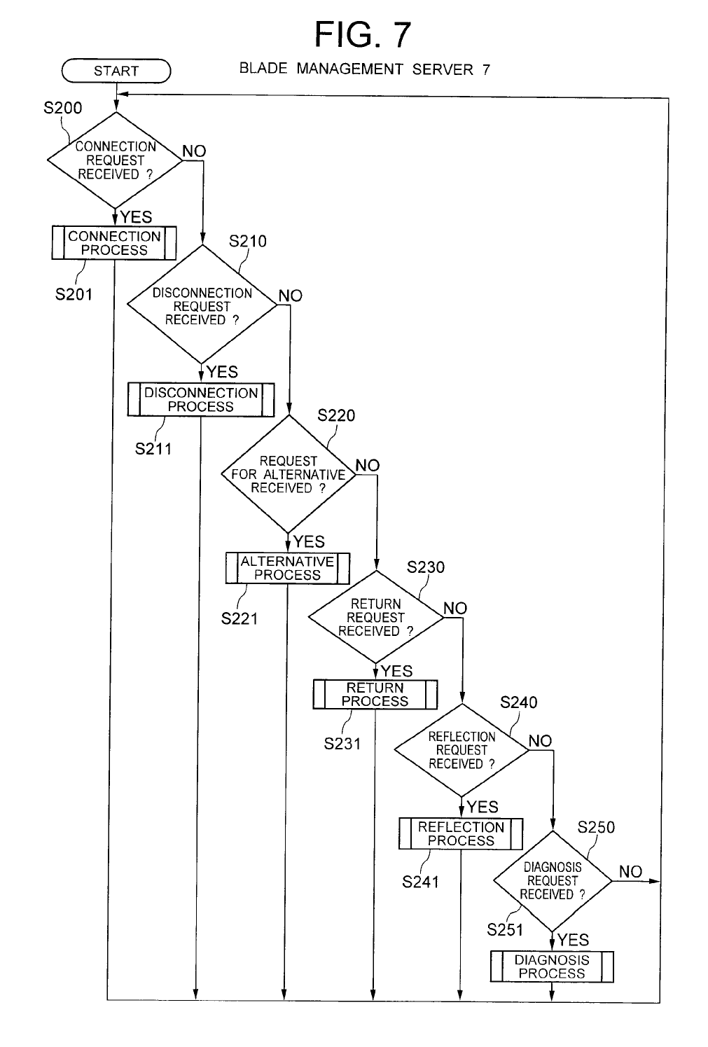

FIG. 7 is a flowchart to which reference is made in explaining an example of the operation of blade management server 7. The CPU 701 fundamentally executes this flow of processes according to the programs. However, for the convenience of explanation, the programs are assumed here as the main body for executing the flow of processes.

When the allocation status management program 7044 receives a connection request from the remote operating terminal 2 through the NIC 703 (YES in step S200), it makes connection process for connecting a certain one of the blade PCs 1 to the remote operating terminal 2 as will be described later (S201). In addition, when the allocation status management program 7044 receives a disconnection request from the remote operating terminal 2 through the NIC 703 (YES in step S210), it makes disconnection process for disconnecting the corresponding blade PC 1 from the remote operating terminal 2 as will be described later (S211).

In addition, when the allocation status management program 7044 receives a request for alternative from the remote operating terminal 2 through NIC 703 (YES in step S220), it makes the alternative process for connecting the terminal 2 to an alternative apparatus substituting for the “statically allocated” blade PC 1 (S221).

Moreover, when the allocation status management program 7044 receives a return request from the remote operating terminal 2 through the NIC 703 (YES in step S230), it makes the return process for returning the “alternatively allocated” blade PC 1 as will be described later (S231).

Furthermore, when the allocation status management program 7044 receives a reflection request from the remote operating terminal 2 through the NIC 703 (YES in step S240), it makes the reflection process for reflecting the user information on the blade PC 1 that is currently connected to the remote operating terminal 2 as will be described later (S241).

Then, when the inquiry response program 7046 receives a diagnosis request from the remote operating terminal 2 through the NIC 703 (YES in step S250), it makes the diagnosis process for confirming the operation status of the blade PC 1 that is currently connected to the remote operating terminal 2 in cooperation with the operation status management program 7045 as will be described later (S251).

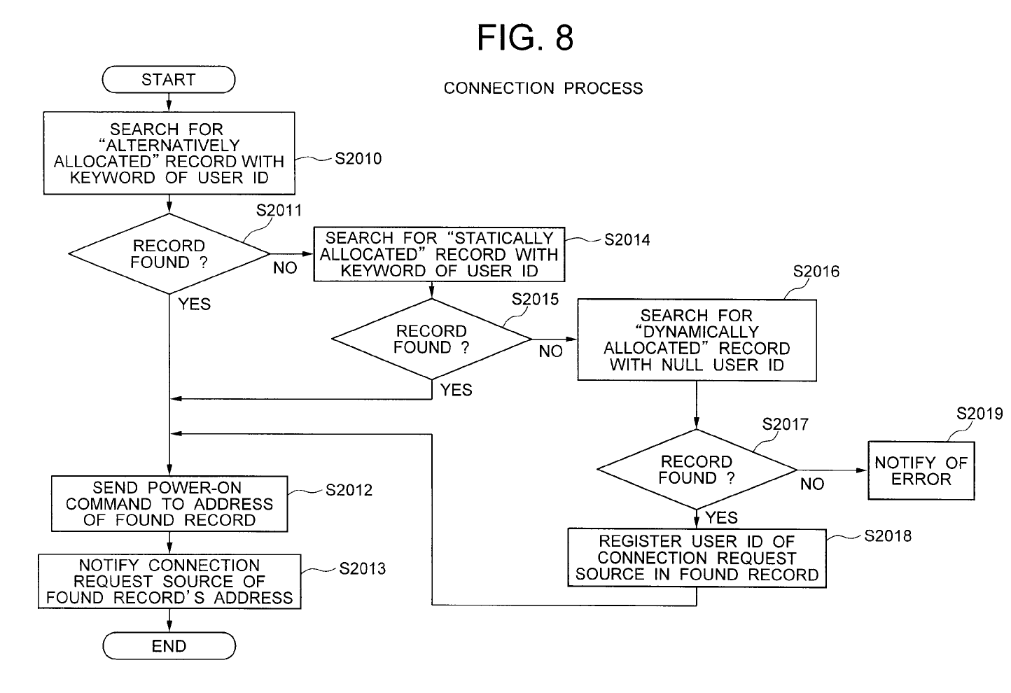

FIG. 8 is a flowchart useful for explaining an example of the connection process (S201 of FIG. 7) of the blade management server 7.

First, the allocation status management program 7044 refers to the allocation status management table 7042 to search for the record 70420 that has the field 70423 registering the user ID contained in the connection request, and the field 70424 registering the status of “alternatively allocated” (S2010). If this record 70420 can be found (YES in step S2011), the program goes to step S2012. If it cannot be found (NO in step S2011), the program goes to step S2014.

In step S2014, the allocation status management program 7044 refers to the allocation status management table 7042 to search for the record 70420 that has the field 70423 registering the user ID contained in the connection request and the field 70424 registering the status of “statically allocated”. If this record 70420 can be found (YES in step S2015), the program goes to step S2012. If it cannot be found (NO in step S2015), the program goes to step S2016.

In step S2016, the allocation status management program 7044 refers to the allocation status management table 7042 to search for the record 70420 that has the field 70423 registering null data and the field 70424 registering the status of “dynamically allocated”. If this record 70420 can be found (YES in step S2017), the allocation status management program 7044 causes the user ID contained in the connection request to be registered in the field 70423 (S2018).

Then, the program goes to step S2012. If the record cannot be found (NO in step S2017), the program makes a predetermined error process such as transmitting an error message of no available blade PC 1 via the NIC 703 to the remote operating terminal 2 that transmitted the connection request (S2019), and then this flow ends.

In step S2012, the allocation status management program 7044 transmits a power-on command via the NIC 703 to the blade PC 1 that has the network address registered in the field 70422 of the record 70420 thus found. Then, the allocation status management program 7044 sends the network address of the blade PC 1 that has transmitted the power-on command to the remote operating terminal 2 of the connection request source via the NIC 703 (S2013), and this flow ends.

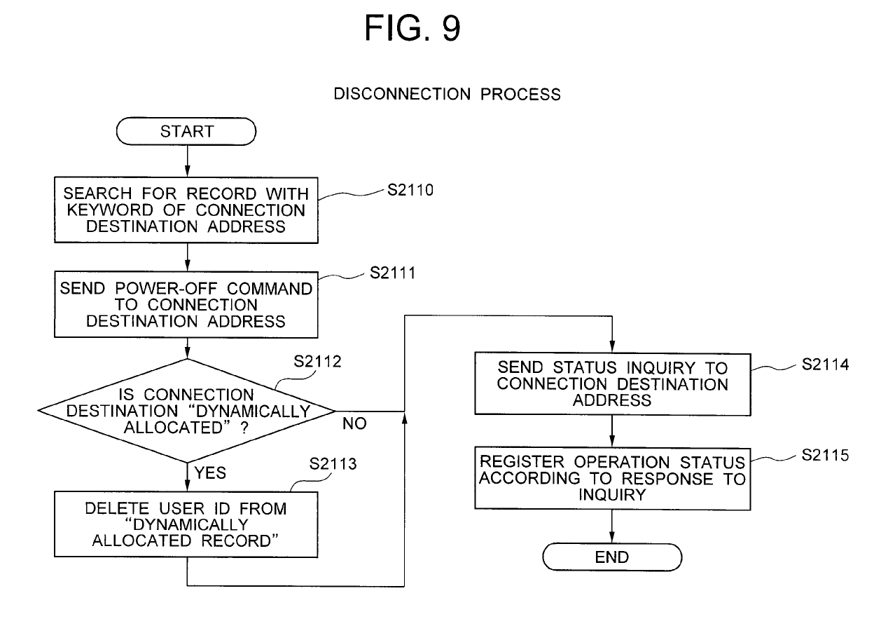

FIG. 9 is a flowchart useful for explaining an example of the disconnection process (S201 of FIG. 7) of the blade management server 7.

First, the allocation status management program 7044 searches for the record 7420 that has the field 70422 registering the same network address as that of the connection destination blade PC 1 that is contained in the disconnection request received from the remote operating terminal 2, and specifies the blade ID registered in the field 70421 of this record 7420 (S2110). Then, the allocation status management program 7044 transmits a power-off command to the network address of this connection destination blade PC 1 via the NIC 703 (S2111).

Then, the allocation status management program 7044 checks if the allocation type registered in the field 70424 of the record 7420 found in step S2110 is “dynamically allocated” (S2112). If it is “dynamically allocated” (YES in step S2112), the user ID is deleted from the field 70423 of this record 70420 (S2113), and the program goes to step S2114. If it is not “dynamically allocated” (NO in step S2112), the program immediately goes to step S2114.

In step S2114, the allocation status management program 7044 transmits the power-off command to the network address of this connection destination blade PC 1 via the NIC 703. Then, after a predetermined time (longer than at least the time that is taken for the blade PC 1 to make end process) is elapsed, the program 7044 sends the inquiry of the status of the connection destination PC 1 to the operation status management program 7045.

The operation status management program 7045 responds to this inquiry to transmit the inquiry of the status to the network address of this connection destination blade PC 1 via the NIC 703. When receiving the operation status from the connection destination blade PC 1, it refers to the operation status management table 7043 to search for the record 7430 that has the field 70431 registering the blade ID of the connection destination blade PC 1, and registers the acquired operation status in the field 70432 of the found record 70430 (S2115).

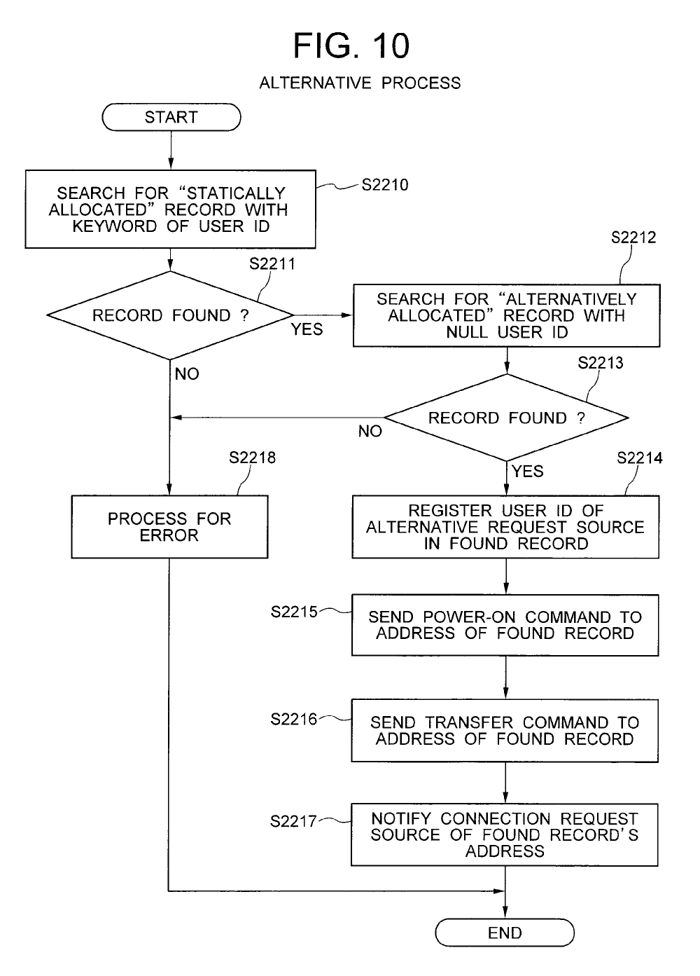

FIG. 10 is a flowchart useful for explaining an example of the alternative process (S221 of FIG. 7) of the blade management server 7.

First, the allocation status management program 7044 refers to the allocation status management table 7042 to search for the record 70420 that has the field 70423 registering the user ID contained in the request for alternative received from the user operating terminal 2, and the field 70424 registering the allocation type of “statically allocated” (S2210). If this record 70420 can be found (YES in step S2211), the program goes to step S2212. If it cannot be found (NO in step S2211), the program makes a predetermined error process such as transmitting to the remote operating terminal 2 of the alternative-request source via NIC 703 an error message saying that the connection should be requested first (S2218). Then, this flow ends.

In step S2212, the allocation status management program 7044 refers to the allocation status management table 7042 to search for the record 70420 that has the field 70423 with null data registered, and the field 70424 with “alternatively allocated” registered, and that has the field 70421 of which the registered blade ID is the same as that of the record 70430 of the operation status management table 7043 that indicates operation status of “available”.

If this record 70420 can be found (YES in step S2213), the program goes to step S2214. If it cannot be found (NO in step 2213), the program makes a predetermined error process such as transmitting via NIC 703 to the remote operating terminal 2 of the alternative-request source an error message saying that there is no available alternative blade PC 1 (S2218). Then, this flow ends.

In step S2214, the allocation status management program 7044 causes the user ID contained in the request for alternative received from the user operating terminal 2 to be registered in the field 70423 of the found record 70420. Then, the allocation status management program 7044 transmits via the NIC 703 a power-on command to the blade PC 1 that has the network address registered in the field 70422 of the found record 70420. Then, after a predetermined time (longer than at least the time that is taken for the blade PC 1 to make start process) is elapsed, a transfer command that has the user ID contained in the request for alternative received from the user operating terminal 2 is transmitted to this blade PC 1 (S2216). Subsequently, the allocation status management program 7044 sends the network address of the blade PC 1 that has transmitted the power-on command, to the remote operating terminal 2 of the alternative-request source via the NIC 703 (S2017). Then, this flow ends.

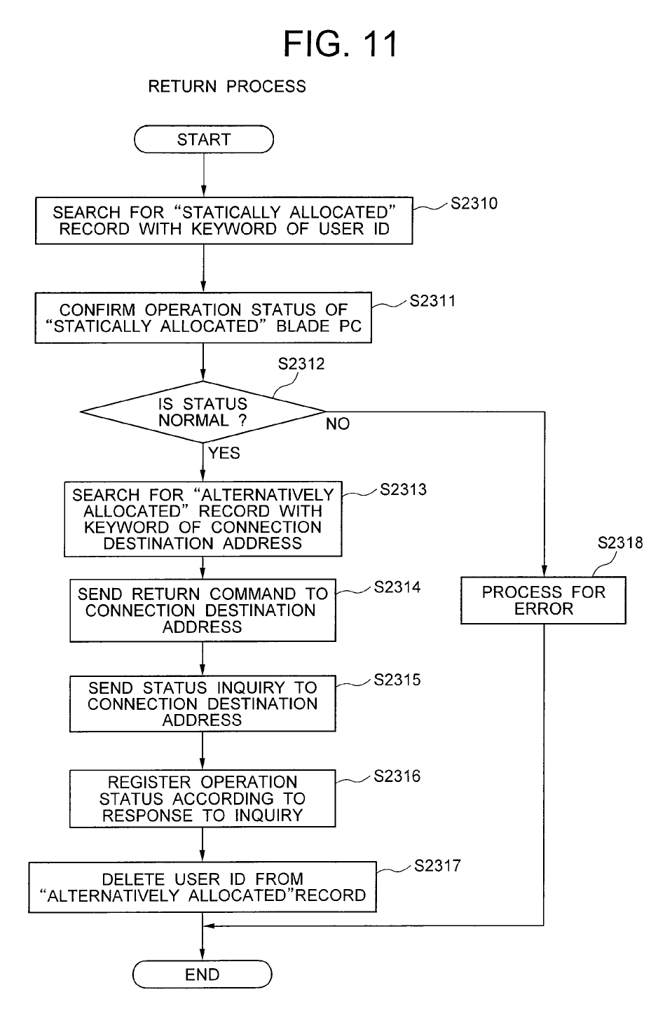

FIG. 11 is a flowchart useful for explaining an example of the return process (S231 of FIG. 7) of the blade management server 7.

First, the allocation status management program 7044 refers to the allocation status management table 7042 to search for the record 70420 that has the field 70423 registering the user ID contained in the return request, and the field 70424 with “statically allocated” registered. Then, it specifies the blade ID registered in the field 70421 of the found record 70420 (S2310).

Then, it refers to the operation status management table 7043 to search for the record 70430 having the specified blade ID, and confirms the operation status registered in the found record 70430 (S2311). If the operation status is “available” (YES in step S2312), the program goes to step S2313. If the operation status is “failed” (NO in step 2312), it makes a predetermined error process such as transmitting via the NIC 703 to the remote operating terminal 2 of the return request source an error message saying that the blade PC 1 “statically allocated” to the user stays failed (S2318). Then, this flow ends.

In the step S2313, the allocation status management program 7044 searches for the record 70420 of which the blade PC 1 is “alternatively allocated” to the user of the remote operating terminal 2 and of which the field 70422 has registered therein the network address of the connection destination contained in the return request, and specifies the blade ID registered in the field 70421 of this record 70420. Then, the program 7044 transmits the return command via the NIC 703 to the network address of the “alternatively allocated” connection destination blade PC 1 (S2314).

Then, after a predetermined time (longer than at least the time that is taken for the blade PC 1 to make end process) is elapsed, the program 7044 orders the operation status management program 7045 to inquire the status of the connection destination blade PC 1. The program 7045 sends the inquiry of status to the network address of the “alternatively allocated” connection destination blade PC 1 via the NIC 703 (S2315). If the program 7045 receives the operation status from the “alternatively allocated” connection destination PC 1, it refers to the operation status management table 7043 to search for the record 7430 that has the field 70431 registering the blade ID of this “alternatively allocated” connection destination blade PC 1. Then, it registers this operation status in the field 70432 of the found record 70430 (S2316).

Thereafter, the allocation status management program 7044 deletes (S2317) the user ID from the field 70423 of the record 70420 (the record 70420 of the “alternatively allocated” blade PC 1) found in step S2313, and this flow ends.

If the return process is automatically executed as the “failed” blade is restored to the state of “available” without receiving the return request from the user operating terminal, the user can make transfer to the new blade PC without being conscious of the return process.

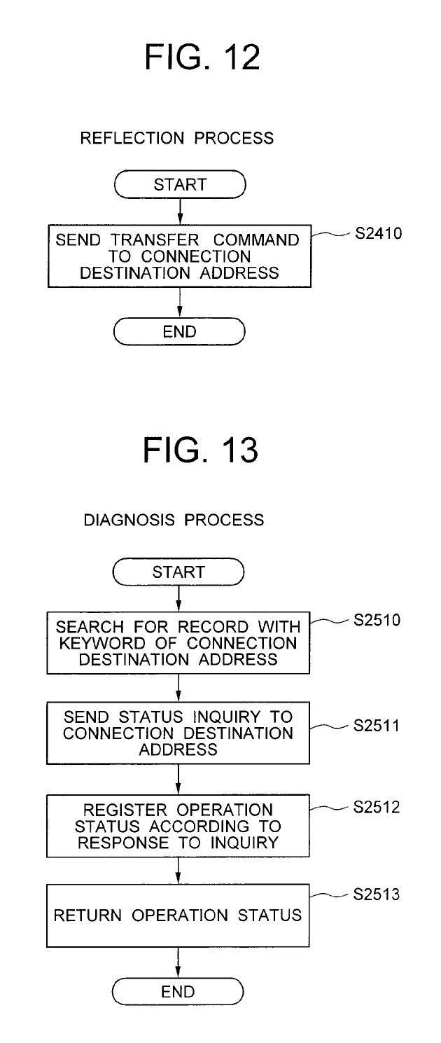

FIG. 12 is a flowchart useful for explaining an example of the reflection process (S241 of FIG. 7) of the blade management server 7.

The allocation status management program 7044 generates the transfer command that has the user ID included in the reflection request received from the remote operating terminal 2, and transmits this transfer command via the NIC 703 to the blade PC 1 that has the network address of the connection destination contained in this reflection request (S2410).

FIG. 13 is a flowchart useful for explaining an example of the diagnosis process (S251 of FIG. 7) of the blade management server 7.

First, the inquiry response program 7046 searches for the record 7420 that has the field 70422 registering the network address of the connection destination blade PC 1 that is contained in the diagnosis request received from the remote operating terminal 2, and identifies the blade ID registered in the field 70421 of this record 7420 (S2510).

Then, the inquiry response program 7046 orders the operation status management program 7045 to inquire the status of the connection destination blade PC 1. The operation status management program 7045 sends an inquiry of status to the network address of this connection destination blade PC 1 via the NIC 703 (S2511).

Thereafter, if the program 7045 receives the operation status from the connection destination blade PC 1, it refers to the operation status management table 7043 to search for the record 70430 that has the field 70431 registering the blade ID of the connection destination blade PC 1, and registers this operation status in the field 70432 of the found record 70430 (S2512).

Subsequently, the inquiry response program 7046 transmits via the NIC 703 to the remote operating terminal 2 of the diagnosis request source the status information registered in the fields 70432 and 70433 of the record 70430 found in step S2512 together with the allocation type information registered in the field 70424 of the record 7420 found in step S2510 (S2513).

Turning back to FIG. 1, the remote operating terminal 2 builds up the VPN between it and the blade PC 1, and transmits to the corresponding blade PC 1 via the VPN the input information (the input operation content inputted via the input unit) that is entered in its own remote operating terminal 2. At the same time, the remote operating terminal 2 receives the video information (the desktop view on the display) from this blade PC 1, and the terminal 2 causes its own display to display this video information.

The remote operating terminal 2 is the so-called HDD-less type PC that is constructed not to be capable of local connection or network connection of printer, external drive, external memory and so on. In other words, the remote operating terminal 2 is constructed to be capable of using only the printer, external drive, external memory and so on that are locally connected or connected via a network to the blade PC 1. This construction can reduce the possibility of the leakage of the information from the remote operating terminal 2 due to, for example, the robbery of the terminal 2.

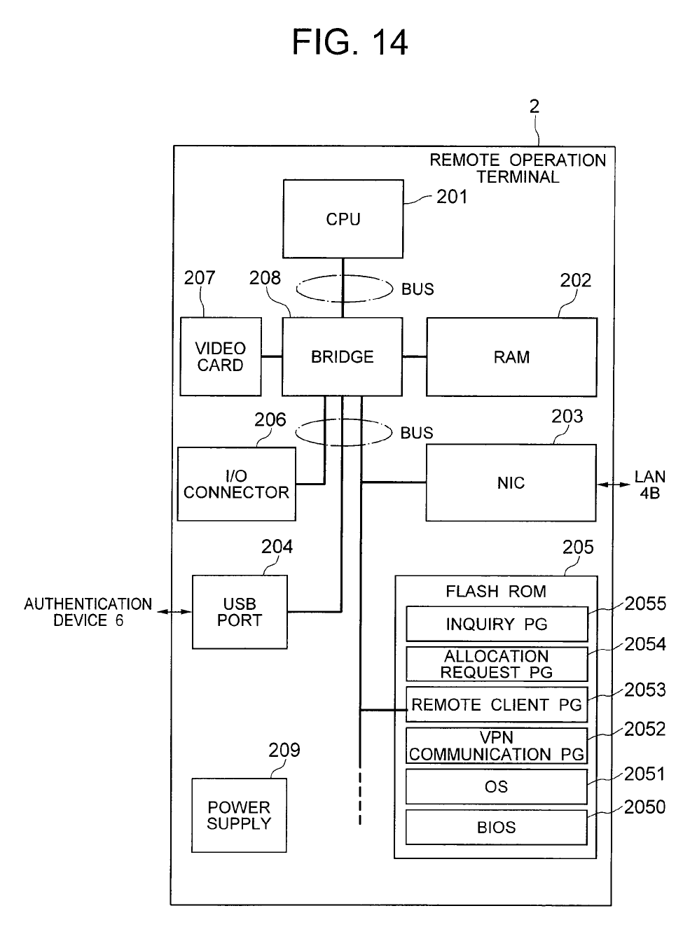

FIG. 14 is a block diagram showing an example of the construction of the remote operating terminal 2. As illustrated, the remote operating terminal 2 has a CPU 201, a RAM 202 that functions as the work area of the CPU 201, a NIC 203 for connecting to the LAN 4B, an USB port 204 for connecting the authentication device (USB device) 6, a flash ROM 205, an I/O connector 206 for connecting the keyboard and the mouse, a video card 207 for connecting a display, a bridge 208 for relaying information on buses BUS that connect these elements 201-207, and a power supply 209.

The flash ROM 205 has, at least, a BIOS 2050, an OS 2051, a VPN communication program 2052, a remote client program 2053, an allocation request program 2054 and an inquiry program 2055 stored therein. The CPU 201, after the power supply 209 is turned on, first makes access to the flash ROM 205 and executes the BIOS 2050, thereby recognizing the system structure of the remote operating terminal 2.

The OS 2051 is the program necessary for the CPU 201 to totally control the elements 202-209 of the remote operating terminal 2 and to execute the programs 2052-2055 which will be described later. Under the control of BIOS 2050, the CPU 201 loads the OS 2051 from the flash ROM 205 to the RAM 202, and executes it. Thus, the CPU 201 totally controls the elements 202-209 of the remote operating terminal 2. The OS 2051 used in this embodiment is a relatively small-sized built-in type OS that can be stored in the flash ROM 205.

The OS 2501 forces the CPU 201 to make the next authentic process at the starting time. In other words, the CPU 201 controls the display connected to the video card 207 to display the input form of user ID and password and accepts the user's input of user ID and password through the keyboard and mouse connected to the I/O connector 206. Then, the CPU 201 transmits the accepted user ID and password to the authentic device 6 connected to the USB port 204, thus requesting for user authentication. Only when the user authentication is approved, the start process is completed. If the user authentication fails, error process such as outputting an error message is performed, and the start process is stopped without being completed.

The VPN communication program 2052 is used to build up the VPN between the terminal and the blade PC 1 having the network address notified of from the blade management server 7, and it is, for example, a communication program using Ipsec. The CPU 201 operates according to the OS 2051 to control the VPN communication program 2052 to be loaded from the flash ROM 205 to the RAM 202 and to execute the program. Thus, the CPU 201 transmits a communication start request to the network address notified of from the blade management server 7 via NIC 203, builds up the VPN between the terminal and the blade PC 1 having the network address, and communicates with the blade PC 1 through this VPN.

The remote client program 2053 is used for the remote operating terminal 2 to remotely access the desktop of the blade PC 1, and it is, for example, a client (viewer) program of VNC. The CPU 201 operates according to the OS 2051 to control the remote client program 2053 to be loaded from the flash ROM 205 to the RAM 202, and to execute the program. Thus, the CPU 201 transmits the input information (the operation content inputted via the keyboard and mouse) of the I/O connector 206 to the blade PC 1 via the VPN, and causes the video information (the desktop view on the display) sent from the corresponding blade PC 1 via the VPN to be displayed on the display (not shown) connected to the video card 207.

The allocation request program 2054 is used to request the blade management server 7 to connect to and disconnect from the blade PC 1 allocated to its own remote operating terminal 2, to provide an alternative blade PC 1 to the corresponding blade PC 1 and to return this alternative, and request it to transfer the user's environment to the corresponding blade PC 1.

The inquiry program 2055 is used to ask the blade management server 7 about the operation status of the blade PC 1 that has the network address notified of from the blade management server 7.

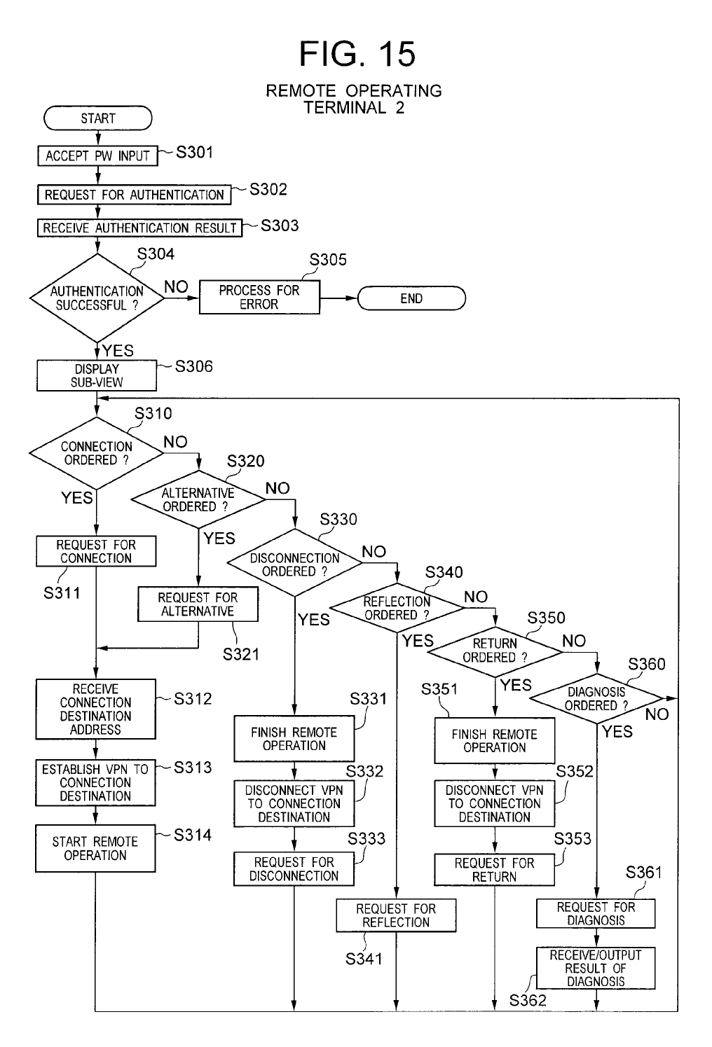

FIG. 15 is a flowchart useful for explaining an example of the operation of the remote operating terminal 2. The CPU 201 essentially executes this flow according to the programs. However, for the convenience of explanation, the programs are assumed here as the main body for executing this flow.

The OS 2051 controls the display connected to the video card 207 to indicate the input form for user ID and password at the starting time, and accepts the input of user ID and password from the user via the keyboard and mouse connected to the I/O connector 206 (S301). Then, it transmits the accepted user ID and password to the authentication device 6 connected to the USB port 204 to request for the authentication (S302), and receives the result of the authentication from the authentication device (S303).

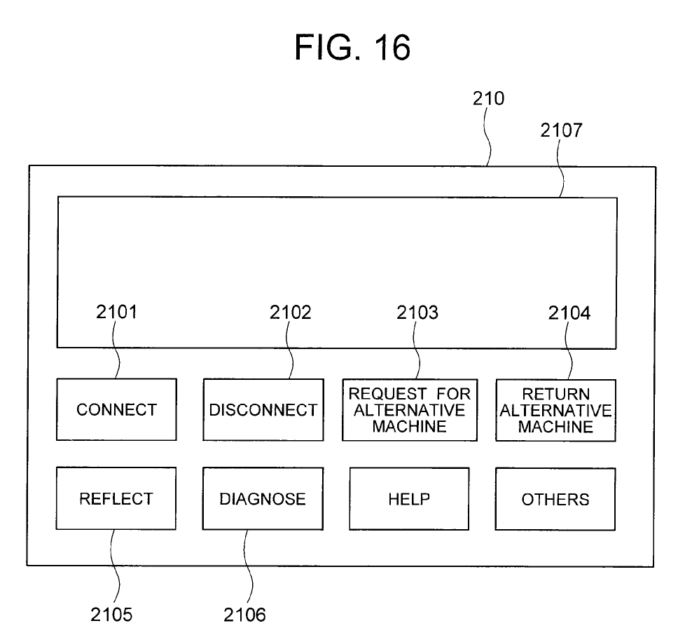

If the authentication result fails (NO in step 304), the OS 2051 makes an error process such as supplying an error message to the display connected to the video card 207 (S305), and finishes this flow. If the authentication result is successful (YES in step 304), the OS 2051 controls the display connected to the video card 207 to indicate a sub view 210 as, for example, shown in FIG. 16, and accepts the instruction from the user via the keyboard and mouse connected to the I/O connector 206 (S306).

In FIG. 16, reference numeral 2101 represents the connection button for accepting the instruction for connection, 2102 the disconnection button for accepting the instruction for disconnection, 2103 the alternative-machine request button for accepting the instruction to request an alternative, 2104 the return button for the instruction to return the alternative, 2105 the reflection button for the instruction to reflect user information, 2106 the diagnosis button for the instruction to diagnose blade PC 1, and 2107 the message area for use in displaying the message (diagnosis result and error message) sent from the blade management server 7. The user operates the keyboard and mouse connected to the I/O connector 206 so that the cursor not shown can be moved to select desired one of the buttons 2101-2106.

The OS 2051, when accepting the instruction to connect from the user (S310), orders the allocation request program 2054 to transmit the connection request. The allocation request program 2054 is responsive to this instruction to generate the connection request including the user ID accepted from the user in step S301, and transmits it to the blade management server 7 via the NIC 203 (S3111). Then, the program goes to step S312.

Moreover, accepting the alternative command from the user (S320), the OS 2051 orders the allocation request program 2054 to transmit the request for alternative. The allocation request program 2054 generates the request for alternative including the user ID received from the user in step 301, and transmits it to the blade management server 7 via the NIC 203 (S321). Then, the program goes to step 312.

In step S312, when receiving the network address of the connection destination blade PC 1 from the blade management server 7, the allocation request program 2054 notifies the remote client program 2053 of this network address. The remote client program 2053 further notifies the VPN communication program 2052 of the network address of blade PC 1 sent from the allocation request program 2054, thus ordering it to establish the VPN. The VPN communication program 2052 establishes the VPN between the terminal and the blade PC 1 having this network address (S313). Then, the remote client program 2053 forces the blade PC 1 to start to remotely operate in cooperation with the remote server program 1043 of the blade PC 1 having this network address (S314).

In addition, when accepting the disconnection instruction from the user (S330), the OS 2051 orders the allocation request program 2054 to transmit the disconnection request. The allocation request program 2054 first controls the remote client program 2053 to finish the remote operation of blade PC 1 (S331), and then controls the VPN communication program 2052 to disconnect the VPN between the terminal and the blade PC 1 (S332). In addition, the allocation request program 2054 generates the disconnection request including the network address of the blade PC 1 as a partner in the disconnected VPN, and transmits this disconnection request to the blade management server 7 via the NIC 203 (S333).

Moreover, accepting the reflection command from the user (S340), the OS 2051 orders the allocation request program 2054 to transmit the reflection request. The allocation request program 2054 generates the reflection request including the network address of the blade PC 1 as a partner in the VPN, and transmits it to the server management server 7 via the NIC 203 (S341).

Also, accepting the return command to return the alternative from the user (S350), the OS 2051 orders the allocation request program 2054 to transmit the return request. The allocation request program 2054 first controls the remote client program 2053 to finish the remote operation on the blade PC 1 (S351), and controls the VPN communication program 2052 to disconnect the VPN between the terminal and the blade PC 1 (S352). Subsequently, the allocation request program 2054 generates the return request including the user ID and the network address of the blade PC 1 as a partner in the disconnected VPN, and transmits it to the blade management server 7 via the NIC 203. (S353).

Furthermore, accepting the diagnosis command to diagnose the blade PC 1 from the user (S360), the OS 2051 orders the inquiry program 2055 to transmit the diagnosis request. The inquire program 2055 generates the diagnosis request including the network address of the blade PC 1 as a partner in the VPN, and transmit it to the blade management server 7 via the NIC 203 (S361). Then, the information (operation status and allocation type) of blade PC 1 received from the blade management server 7 is displayed in the massage area 2107 of the sub view 210 as, for example, shown in FIG. 16 (S362).

Turning back to FIG. 1, the authentication device 6 authenticates the user ID and password received from the remote operating terminal 2, and notifies the remote operating terminal 2 of the result of the authentication.

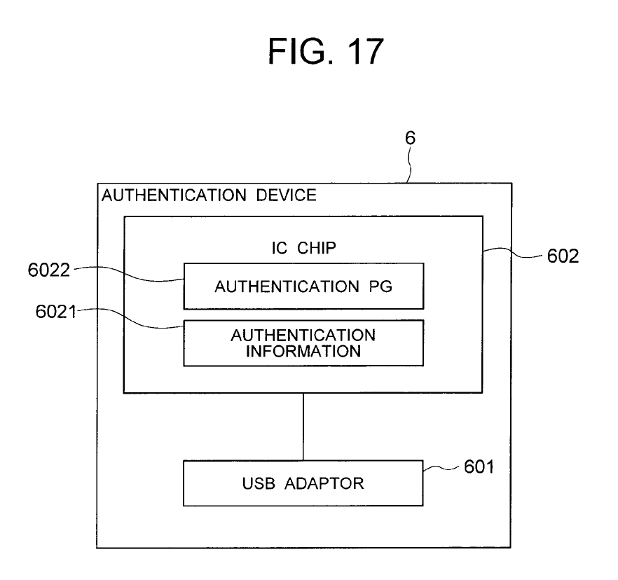

FIG. 17 is a block diagram showing an example of the construction of the authentication device 6. As illustrated, the authentication device 6 has an USB adaptor 601 for connecting to the USB port 204 of the remote operating terminal 2, and an IC chip 602.

The IC chip 602 has authentication information 6021 and an authentication program 6022 stored therein. The authentication device 6 may have a flash memory externally mounted so that part of the data within the IC chip 602 can be stored in this flash memory.

The authentication information 6021 has the ID and password of the user.

The authentication program 6022 is the program that uses the user ID and password inputted in the remote operating terminal 2 that has its own authentication device 6 connected, and the authentication information 6021 in order to authenticate the user.

When the USB adaptor 601 of the authentication device 6 is connected to the USB port 204 of the remote operating terminal 2 so that the remote operating terminal 2 can supply power to the authentication device 6, the IC chip 602 executes the authentication program 6022.

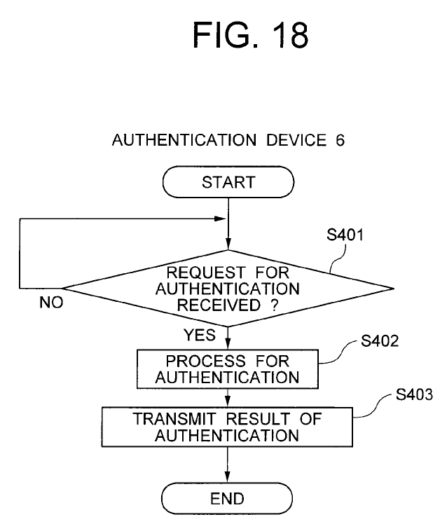

FIG. 18 is a flowchart useful for explaining the operation of the authentication device 6. The IC chip 602 essentially executes this flow according to the program. However, for the convenience of explanation, the program is assumed here as the main body for executing the flow.

When receiving the authentication request from the remote operating terminal 2 (S401), the authentication program 6022 compares the user ID and password contained in the authentication request with those of the authentication information 6021 in order to authenticate the user (S402). Then, the result of the authentication is supplied to the remote operating terminal 2 (S403), and this flow ends.

In the flow shown in FIG. 18, the authentication program 6032 may be installed in the remote operating terminal 2 instead of being installed in the authentication device 6 so that the remote operating terminal 2 can execute this program. Alternatively, part of the authentication program 6032 may be installed in the remote operating terminal 2 so that the remote operating terminal 2 and the authentication device 6 can execute the program in cooperation with each other.

Turning back to FIG. 1, the user information save server 8 retains the user data stored in the blade PC 1.

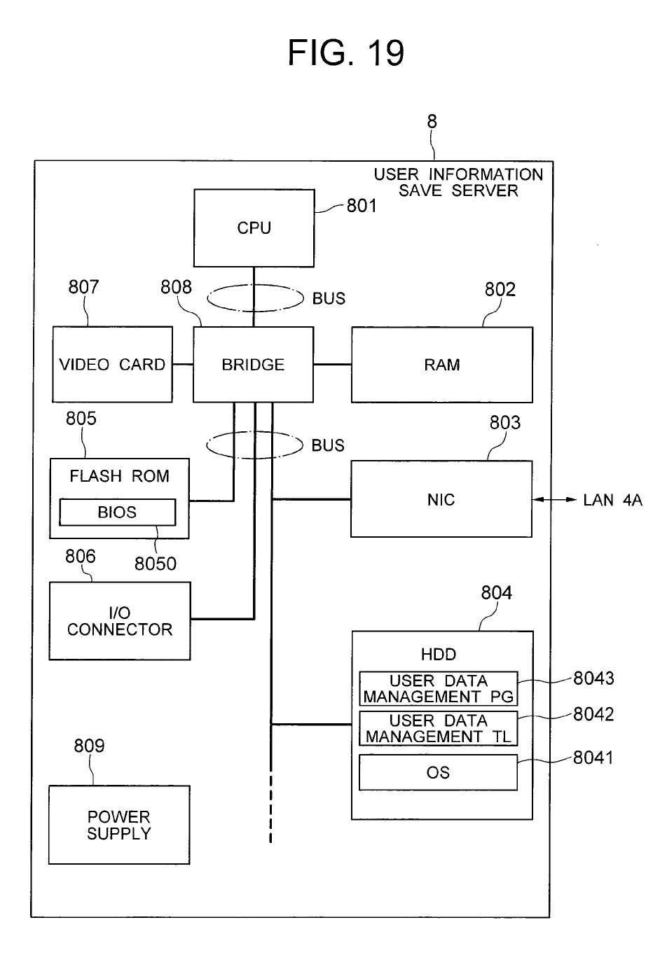

FIG. 19 is a block diagram showing an example of the construction of the user information save server 8. As illustrated, the user information save server 8 has a CPU 801, a RAM 802 that serves as the work area of CPU 801, a NIC 803 for connecting to the LAN 4A, an HDD 804, a flash ROM 805, an I/O connector 806 for connecting the keyboard and mouse, a video card 807 for connecting the display, a bridge that relays information on buses BUS that connect these elements 801-807, and a power supply 809.

The flash ROM 805 has a BIOS 8050 stored therein. The CPU 801, after the power supply is turned on, first makes access to the flash ROM 805 and executes the BIOS 8050, thus recognizing the system structure of the user information save server 8.

The HDD 804 has at least an OS 8041, a user data management table 8042, and a user data management program 8043 stored therein.

The OS 8041 is the program for the CPU 801 to totally control the elements 802-809 of the user information save server 8 to execute each of programs 8043 which will be described later. Under the control of BIOS 8050, the CPU 801 controls the OS 8041 to be loaded from the HDD 804 to the RAM 802, and executes it. Thus, the CPU 801 totally controls the elements 802-809 of the user information save server 8.

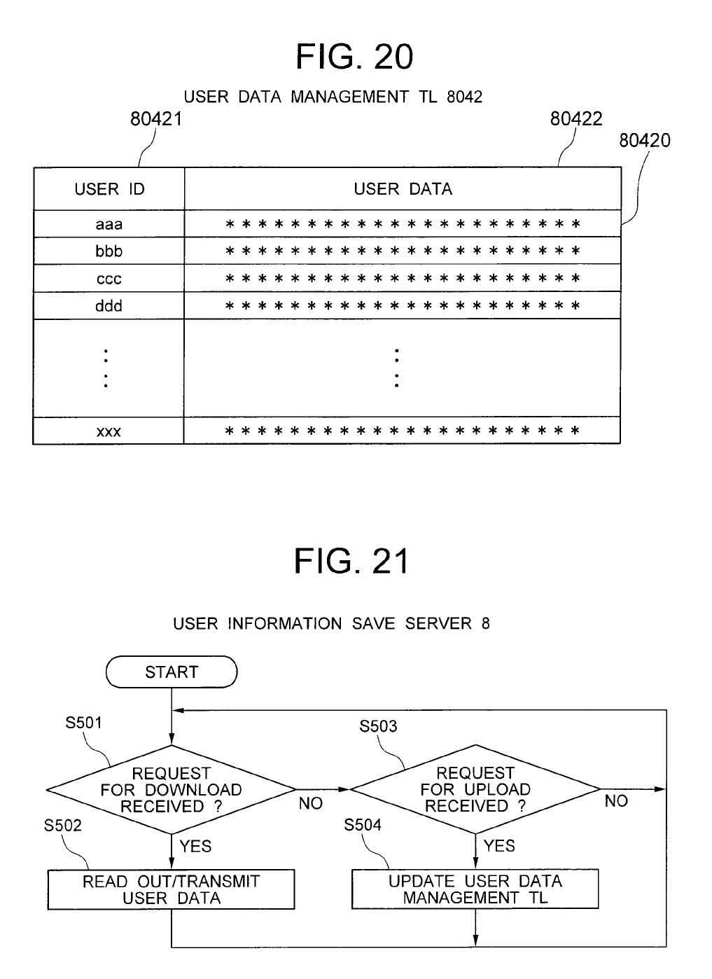

The user data management table 8042 has user data of each user stored therein. FIG. 20 schematically shows an example of the user data management table 8042. As illustrated, the record 80420 is registered for each user. The record 80420 has a field 80421 for registering the user ID of each user, and a field 80422 for registering user data.

Although the user data 80422 is held within the user data management table 8042 as mentioned above, it is not limited to the above, but may be held as follows. For example, since the user data is stored in a logic volume or physical volume of the storage such as HDD, the addresses of the volume in which the user data is stored may be held within the user data management table 8042 in connection with the user ID 80421. In this case, the user data management program 8043 acquires or updates the user data held in the storage region specified by the address associated with the user ID.

The user data management program 8043 is the program that manages the user data registered in the user data management table 8042 to be downloaded to and uploaded from the blade PC 1.

FIG. 21 is a flowchart useful for explaining an example of the operation of the user information save server 8. The CPU 801 essentially executes this flow according to the programs. However, for the convenience of explanation, the programs are assumed here as the main body for executing the flow.

When the user data management program 8043 receives a download request including the user ID from the blade PC 1 via the NIC 803 (YES in step S501), it reads out the user data that is registered in the user data management table 8042 associated with this user data, and transmits it to the blade PC 1 of the download request transmission source (S502).

In addition, when the user data management program 8043 receives an upload request including the user ID and user data from the blade PC 1 via the NIC 803 (YES in step S503), it updates the user data registered in the user data management table 8042 associated with this user ID so that it can be changed to the user data received from this blade PC 1 (S504).

The operation of the remote desktop system of the above construction will be briefly described below.

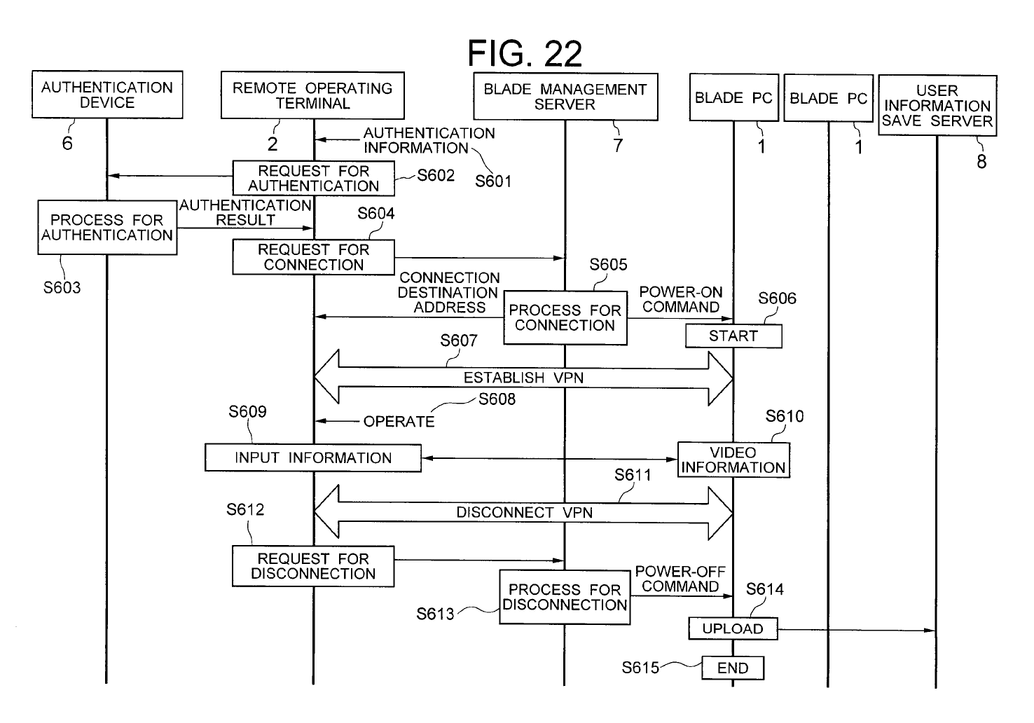

FIG. 22 is a flowchart useful for explaining an example of the operation of the blade PC 1 in the case when it is “statically allocated” to the user and is normally operated.

When the user inputs authentication information (user ID and password) at the starting time (S601), the remote operating terminal 2 generates an authentication request including this authentication information, and transmits it to the authentication device 6 (S602).

When receiving the authentication request from the remote operating terminal 2, the authentication device 6 makes authentication process (step S402 in FIG. 18) by using the authentication information 6021 registered in the authentication device 6, and transmits the result of the authentication to the remote operating terminal 2 (S603). The remote operating terminal 2 first confirms that the result of the authentication received from the authentication device 6 is successful, and makes the start process be normally completed, thus the sub view 210 being displayed as, for example, shown in FIG. 16, so that it is ready to accept various operations from the user.

Thus, when accepting a connection command from the user, the remote operating terminal 2 generates a connection request (step S311 in FIG. 15) including the user ID, and transmits it to the blade management server 7 (S604).

When receiving the connection request from the remote operating terminal 2, the blade management server 7 makes the connection process (FIG. 8), thus transmitting to the remote operating terminal 2 the network address of the blade PC 1 “statically allocated” to the user, and transmitting the power-on command to this blade PC 1 (S605). The blade PC 1 turns on the power supply, and makes the start process (step S101 in FIG. 3) (S606).

Thereafter, the remote operating terminal 2 establishes the VPN between it and the blade PC 1 that has the network address received from the blade management server 7 (S607). Then, it starts the remote operation to the blade PC 1. Thus, when the operation content of the user is inputted into the input unit of the remote operating terminal 2 (S608), the input information indicative of this operation content is transmitted to the blade PC 1 as a partner in the VPN (S609), and the video information of the desktop view on which the input information from the user reflects is transmitted from this blade PC 1 to the associated remote operating terminal 2 (S610).

When receiving the disconnection command from the user, the remote operating terminal 2 disconnects the VPN established between the blade PC 1 and the terminal (S611), and transmits the disconnection request (step S333 in FIG. 15) including the network address of the blade PC 1 as a partner in this VPN to the blade management server 7 (S612).

When receiving the disconnection request from the remote operating terminal 2, the blade management server 7 makes the disconnection process (FIG. 9), and transmits the power-off command to the blade PC 1 that has the network address contained in this disconnection request (S613). The blade PC 1 makes the upload process (step S121 in FIG. 3) to the user information save server 8 associated with the user data, and then turns off the power supply, thus making the end process (step S122 in FIG. 3) (S614, 615).

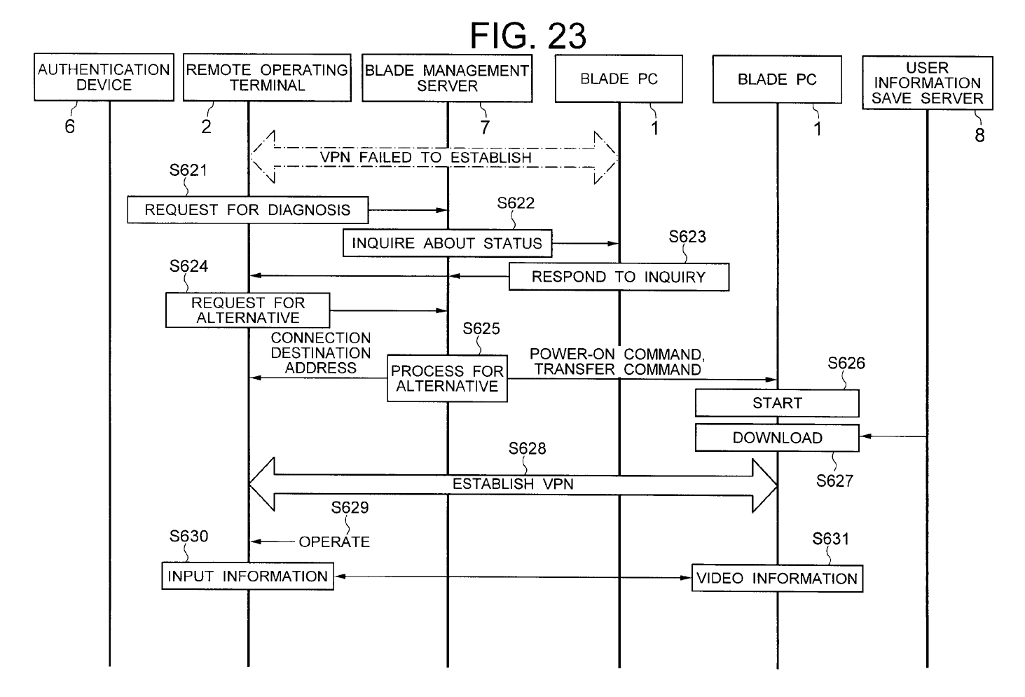

FIG. 23 is a flowchart useful for explaining an example of the operation in the case when the blade PC 1 “statically allocated” to the user breaks down and thus the VPN fails to establish in step S607 in FIG. 22.

When accepting the diagnosis command from the user, the remote operating terminal 2 generates the diagnosis request (step S361 in FIG. 15) that includes the network address of the blade PC 1, or the partner in the VPN failed to establish, “statically allocated” to the user, and transmits it to the blade management server 7 (S621).

When receiving the diagnosis request from the remote operating terminal 2, the blade management server 7 makes the diagnosis process (FIG. 13), thus sending the status inquiry to the blade PC 1 that has the network address contained in this diagnosis request (S622), acquiring the operation status from this blade PC 1 and transmitting it to the remote operating terminal 2 (S623). The user confirms the operation status displayed in the message area 2107 of the sub view 210 as, for example, shown in FIG. 16 so that the user can judge whether the alternative to the blade PC 1 “statically allocated” is to be requested.

When accepting the alternative command from the user, the remote operating terminal 2 generates the request for alternative (step S321 in FIG. 15) including the user ID, and transmits it to the blade management server 7 (S624).

When receiving the request for alternative from the remote operating terminal 2, the blade management sever 7 makes the alternative process (FIG. 10), and determines any one of the blade PCs 1 to be “alternatively allocated” to the user. Then, it transmits the network address of the determined blade PC 1 to the remote operating terminal 2 and also transmits the power-on command and transfer command to this blade PC 1 (S625). The blade PC 1 turns on the power supply, makes the start process (step S101 in FIG. 3) (S626), and then makes the download process (step S151 in FIG. 3) so that the user data associated with the user ID contained in the transfer command can be downloaded from the user information save server 8 (S627).

Subsequently, the remote operating terminal 2 establishes the VPN between it and the blade PC 1 that has the network address received from the blade management server 7 (S628). Then, it starts the remote operation to the blade PC 1 through this VPN. Thus, when the user operates the input unit of the remote operating terminal 2 (S629), the input information indicative of this operation content is transmitted to the blade PC 1 as a partner in the VPN (S631), and the video information of the desktop view on which the input information from the user reflects is transmitted from this blade PC 1 to the associated remote operating terminal 2 (S631).

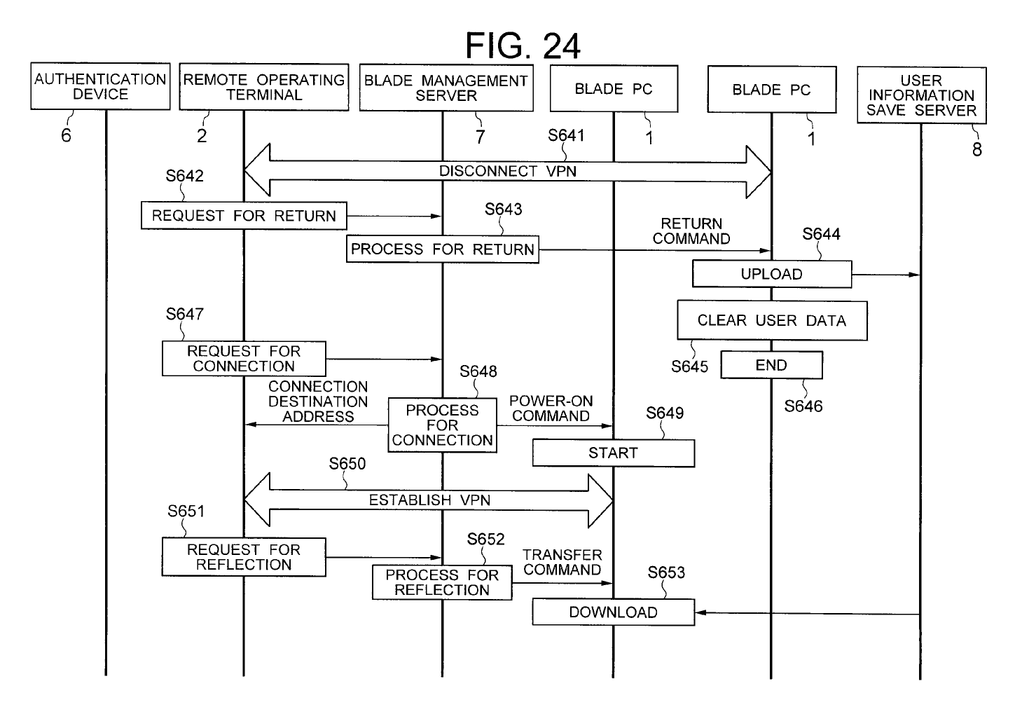

FIG. 24 is a flowchart useful for explaining an example of the operation in the case when the failure of the blade PC 1 “statically allocated” to the user has been completely repaired and thus the “alternatively allocated” blade PC 1 for which the VPN is established in step S628 of FIG. 23 is returned.

When accepting the return command from the user, the remote operating terminal 2 disconnects the VPN established between it and the “alternatively allocated” blade PC 1 (S641), and then it generates the return request (step S353 in FIG. 15) containing the network address of this blade PC 1 and the user ID, and transmits it to the blade management server 7 (S642).

When receiving the return request from the remote operating terminal 2, the blade management server 7 makes the return process (FIG. 11), and transmits the return command to the blade PC 1 that has the network address contained in this return request (S643). The blade PC 1 responds to the return command to make the upload process (step S131 in FIG. 3) for uploading the user data to the user information save server 8 (step S131 in FIG. 3), and then erases the user data within the blade PC 1 (step S132 in FIG. 3). Subsequently, it turns off the power supply, thus making the end process (step S133 in FIG. 3) (S644-S646).

When accepting the connection command from the user, the remote operating terminal 2 generates the connection request (step S311 in FIG. 15) containing the user ID, and transmits it to the blade management server 7 (S647).

When receiving the connection request from the remote operating terminal 2, the blade management server 7 makes the connection process (FIG. 8). The network address of the blade PC 1 “statically allocated” to the user is transmitted to the remote operating terminal 2, and the power-on command is transmitted to this blade PC 1 (S648). The blade PC 1 turns on the power supply, thus making the start process (step S101 in FIG. 3) (S649).

Subsequently, the remote operating terminal 2 establishes the VPN between it and the blade PC 1 that has the network address received from the blade management server 7 (S650). In addition, when accepting the reflection instruction from the user, the remote operating terminal 2 generates the reflection request (step S341 in FIG. 15) containing the network address of the blade PC 1 as a partner in the VPN and the user ID, and transmits it to the blade management server 7 (S651).

When receiving the reflection request from the remote operating terminal 2, the blade management server 7 makes the reflection process (FIG. 12). Thus, the transfer command containing the user ID contained in this reflection request is transmitted from the server to the blade PC 1 that has the network address contained in this reflection request (S652).

The blade PC 1 responds to this transfer command to perform the download process (step S151 in FIG. 3) to download the user data associated with the user ID contained in the transfer command from the user information save server 8 (S653).

According to this embodiment, the blade management server 7 responds to the request for alternative from the remote operating terminal 2 to search for the blade PC 1 that stays not allocated, and to notify the user operating terminal 2 of its network address. The remote operating terminal 2 changes the blade PC 1 that this terminal remotely operates from the currently “statically allocated” blade PC 1 to the blade PC 1 that is “alternatively allocated” and that has the network address notified of from the blade management server 7. Therefore, it is possible to reduce the time that is taken for the operation of exchanging from the current blade PC 1 to the alternative blade PC 1.

In addition, according to this embodiment, since the user data held in the user information save server 8 is downloaded to the “alternatively allocated” blade PC 1, the user can continuously use the data produced by the “statically allocated” blade PC 1.

The above embodiment is not limited to the above description, but can be variously changed without departing from the scope of the invention.

For example, the blade management server 7 and user information save server 8 in the above embodiment may be blade-type computers like the blade PC 1. Moreover, the normal tower-type computers may be used in place of the blade-type computers.

In addition, while the VPN for communication is built between the blade PC 1 and the remote operating terminal 2 in the above embodiment, this embodiment is not limited to the above description. For example, when the blade PC 1 and the remote operating terminal 2 exist within the same LAN, communication between those may be made without building the VPN.

Moreover, the VPN is not directly built between the blade PC 1 and the remote operating terminal 2, but it may be built between those through a VPN server provided immediately below the router 3A shown in FIG. 1.

In addition, the above embodiment is constructed so that the operation status management program 7045 registers “available” or “failed” in the field 70433 of the operation status management table 7043 according to the instruction from the operator of blade management server 7. However this embodiment is not limited to the above construction, but may be constructed as follows. For example, it may be constructed so that the mBMC 108 diagnoses its own blade PC 1 and transmits the result of the diagnosis (“available” or “failed”) together with the operation status (“operating” or “suspending”) to the blade management server 7, and that the operation status management program 7045 of the blade management server 7 responds to this transmission to register the operation status and the result of the diagnosis in the fields 70432 and 70433 of the operation status management table 7043.

Also, this embodiment is constructed so that the user data stored in the blade PC 1 is uploaded to the user information save server 8 when the blade PC 1 finishes its operation. However, this embodiment is not limited to this construction. The blade PC 1 may regularly upload the user data to the user information save server 8 or may upload it in response to the reception of the connection request.

In addition, the uploading of the user data to the user information save server 8 may be achieved by the fact that the OS 7041 of the blade management server 7041 remotely copies the user data from the blade PC 1 to the user information retaining sever 8. In this case, the user-data stored region of the HDD of the blade PC may be directly copied. Alternatively, after the volume of the HDD of the blade PC is once mounted by the OS 7041 of the blade management server 7041, it may be copied by using the function of the file system of the OS.

Moreover, the user information save server itself may copy the user data from the blade PC by using the copy function of the OS or other means in response to an instruction from the blade management server 7041 or mBMC 708.

Also, the mBMC 708 in which the data transmitting function of HDD 704 is incorporated may read out the user data from within the HDD 704 and transmit it through the NIC 703 to the user information save server 8. The mBMC 708 can detect the abnormality of the blade PC by monitoring the temperature, voltage, on/off of the fan, and so on of the CPU and motherboard. When detecting the abnormality of the blade PC, the mBMC 708 makes use of its data transfer function to transfer the user data so that the user data immediately before the blade PC ends its operation because of abnormality can be retained in the user information save server.

Thus, if the user data can be transmitted by the functions of the blade management server 7041, user information save server and mBMC, the user data can be stored in the user information save server even though the OS of the blade PC cannot utilize its data transfer function because of hangup. Therefore, the user can transfer the user data to a new alternative machine to continue the process that takes over the status in which the OS of the blade PC made hangup.

Moreover, while the above embodiment downloads the user data to the alternative machine after once storing the user data in the user information save server, the user information may be directly transferred to the alternative machine by using not the user information save server but the transfer functions of the blade management server 7041, user information save server and mBMC.

In addition, the interface to the authentication device 6 and remote operating terminal 2 in the above embodiment is not limited to the USB. The authentication device 6 may be any authentication device as far as it is constructed to be able to communicate with the remote operating terminal 2. For example, it may be a device detachably connected to the remote operating terminal 2 like a PC card or may be another device to be able to communicate with the remote operating terminal 2 without inserting it by using short range radio communication such as Bluetooth (registered trademark).

Moreover, in the above embodiment, the blade management server and user information save server may be constructed by using a single blade PC, and both the blade management and user information storage may be performed by a single server with the blade management server acted both as itself and as the function of the user information save server. In addition, the user information save server may use a storage system having a plurality of physical storage devices or use a NAS (Network Attached Storage).

Moreover, in the above embodiment, the operation flow of the remote operating terminal 2 as shown in FIG. 15 may be modified as follows.

That is, the OS 2051, when accepting the connection instruction from the user (YES in step S310), causes the inquire program 2055 to generate a diagnosis request containing the user ID in advance of the connection request (S311), and to transmit it to the blade management server 7 via the NIC 203.

In the blade management server 7, the inquiry response program 7046, when receiving the diagnosis request (step S250 in FIG. 7), specifies the blade ID and network address of the blade PC 1 “statically allocated” to the user by referring to the operation status management table 7042 with a keyword of the user ID contained in this diagnosis request. Then, the diagnosis process (step S251 in FIG. 7) shown in FIG. 13 is performed by using the specified blade ID and network address, and the operation status is sent back to the remote operating terminal 2.

In the remote operating terminal 2, the inquiry program 2055 notifies the OS 2051 of the operation status received from the blade management server 7. When this operation status is “available”, the OS 2051 goes to step S311, where it causes the allocation request program 2054 to transmit the connection request to the blade management server 7. When the operation status is “failed”, the program goes to step S321, where it causes the allocation request program 2054 to transmit the request for alternative to the blade management server 7.

Thus, by a single instruction (button operation), the user can make its own remote operating terminal 2 be connected to the blade PC 1 “statically allocated” to the user and to the alternative PC 1 if the “statically allocated” blade PC 1 is failed.

Moreover, in the above embodiment, the operation flow of the remote operating terminal 2 as shown in FIG. 15 may be modified as follows.

In other words, the OS 2051, when accepting the disconnection instruction from the user (YES in step S330), causes the inquiry program 2055 to generate the diagnosis request containing the user ID in advance of the process (disconnection request) of S331-S333, and to transmit it to the blade management server 7 via the NIC 203.

In the blade management server 7, the inquiry response program 7046, when receiving the diagnosis request (step S250 in FIG. 7), specifies the blade ID and network address of each of all the blades PC 1 allocated to the users by referring to the operation status management table 7042 with a key word of the user ID contained in this diagnosis request. Then, the diagnosis process (step S251 in FIG. 7) as shown in FIG. 13 is carried out by using the specified blade ID and network address and the operation status and allocation type of each of all blades PC 1 allocated to the users are sent back to the remote operating terminal 2.

In the remote operating terminal 2, the inquiry program 2055 notifies the OS 2051 of the operation status and allocation type of blade PC 1 received from the blade management server 7. The OS 2501 makes the process (disconnection request) of S331-S333 when receiving from the program 2055 the operation status and allocation type of a single blade PC 1 “statically allocated” or “dynamically allocated”. When receiving the operation status and allocation type of a total of two “statically allocated” or “dynamically allocated” blade PCs 1 from the inquiry program 2055, the OS checks if the operation status of the “statically allocated” blade PC 1 is “available”. If it is “available”, the OS makes the process (return request) of S351-S353. If it is not “available”, the OS makes the process (disconnection request) of S331-S333.

Thus, at the end of the operation of the alternative blade PC 1, the user can return the alternative blade PC 1 by a single instruction (button operation) when the blade PC 1 “statically allocated” to the user is restored from the failure.

Moreover, in the above embodiment in which an alternative machine is allocated in response to the order from the user, when the mBMC detects such an abnormality of the blade PC as when a high-load-on-CPU condition in which the load-on-CPU is higher than a predetermined value continues for a constant time, or when the HDD gives rise to an abnormality like becoming irresponsive or when the OS does not respond, it may be performed that the mBMC transmits the abnormal information of the blade PC to the blade management server, and that the blade management server makes an alternative machine allocation process according to this abnormal information of the blade PC.

In this case, threshold information is previously stored in the storage device or mBMC of the blade PC, and the mBMC acquires the performance information and load information of blade PC, and when it exceeds the threshold, transmits information of such abnormality occurrence to the blade management server, which then responds to this abnormality information to make the process for allocating an alternative machine.

In addition, whether the value exceeds a threshold is not judged by the blade PC, but may be judged by the blade management server. The mBMC regularly transmits the performance information and load information of the motherboard of the blade PC to the blade management server to compare with the threshold information of the load on the CUP, memory, HDD and network that is stored in the storage of the blade management server. If the load exceeds a predetermined threshold, an alternative machine is allocated.

If the allocation of an alternative machine and the return process are automatically performed in response to the command from the blade management server or mBMC without the order from the user, the user can seamlessly transfer to a new environment without being conscious of the allocation of an alternative machine.

Moreover, when the blade management server transmits to the blade PC the information for confirming that the blade PC is normally operating, and when any response is not sent back for a constant time because of its hangup or the like, a process for allocating an alternative machine may be performed according to the above no response.

Furthermore, in the above embodiment, the group ID of a group of users to which the blade PCs 1 specified by the blade IDs registered in the field 70421 are allocated may be previously registered in each record 70420 of the allocation status management table 7042 of the blade management server 7.

Then, when the record 70420 of “dynamically allocated” with which the user IDs are not associated is searched for by referring to the allocation status management table 7042 (step S2016 in FIG. 8), the searching may be performed for the record 70420 that has the group ID of the group belonging to the user that is specified by the user ID contained in the connection request. Similarly, when the record 70420 of “alternatively allocated” with which the user ID is not associated is searched for by referring to the allocation status management table 7042 (step S2212 in FIG. 10), the searching may be performed for the record 70420 that has the group ID of the group belonging to the user that is specified by the user ID contained in the alternative request.

For example, if the group ID and the inherent information of the user (user name and so on) are coupled to form a user ID, the group ID can be immediately identified from the user ID without using a conversion table.

Thus, the applications and group data installed in the blade PC can be customized in association with the group used.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A management server for managing connection among a user information server, a plurality of processors, and a plurality of operating terminals connected via a network, comprising:
an allocation storage for storing both information of processors each being allocated to a user Identifier (ID) and information of processors each being not allocated to a user ID, both of the processors each being connectable with an operating terminal; and
an allocation manager that refers, upon a request for connection with a processor from an operating terminal with a user ID, to an allocation table by use of the user ID of the operating terminal to specify a processor that is allocated to the user ID, refers, upon a request for alternative from the operating terminal with the user ID, to the allocation table by use of the user ID of the operating terminal to specify both a processor that is allocated to the user ID and a processor that is not allocated to the user ID, orders the processor that has been allocated and specified to store user data allocated to the user ID in a storage of the user information server, and orders the processor that has not been allocated but specified to acquire the user data stored in the storage of the user information server.

2. The management server according to claim 1, wherein said allocation manager refers, upon a return request from an operating terminal with a user ID, to the allocation table by use of the user ID of the operating terminal to specify both the processor that is allocated to the user ID and the processor that is not allocated to the user ID, orders the processor that has not been allocated but specified to store the user data allocated to the user ID in the storage of the user information server, and orders the processor that has been allocated and specified to acquire the user data allocated to the user ID stored in the storage of the user information server.

3. A management method for managing connection among a user information server, a plurality of processors, and a plurality of operating terminals connected via a network, comprising the steps of:
storing, with a management server, both information of processors each being allocated to a user ID and information of processors each being not allocated to a user ID in an allocation storage, both of the processors each being connectable with an operating terminal; and
referring, with said management server, upon a request for connection with a processor from an operating terminal with a user ID, to an allocation table by use of the user ID of the operating terminal to specify a processor that is allocated to the user ID, referring, upon a request for alternative from the operating terminal with the user ID, to the allocation table by use of the user ID of the operating terminal to specify both a processor that is allocated to the user ID and a processor that is not allocated to the user ID, ordering the processor that has been allocated and specified to store user data allocated to the user ID in a storage of the user information server, and ordering the processor that has not been allocated but specified to acquire the user data stored in the storage of the user information server.

4. The management method according to claim 3, wherein said management server refers, upon a return request from an operating terminal with a user ID, to the allocation table by use of the user ID of the operating terminal to specify both the processor that is allocated to the user ID and the processor that is not allocated to the user ID, orders the processor that has not been allocated but specified to store the user data allocated to the user ID in the storage of the user information server, and orders the processor that has been allocated and specified to acquire the user data allocated to the user ID stored in the storage of the user information server.

5. An information processing system comprising:
a user information server;
a plurality of processors connected to the user information server via a network;
a plurality of operating terminals connected to the plurality of processors and the user information server via the network; and
a management server for managing connection among a user information server, a plurality of processors, and a plurality of operating terminals connected via a network,
wherein said plurality of processors each comprises a board controller for acquiring performance information on a processor which comprises the board controller to judge whether or not the performance information exceeds a threshold thereby to transmit abnormality information of exceeding the threshold to the management server, and
wherein the management server comprises:
an allocation storage for storing both information of processors each being allocated to a user ID and information of processors each being not allocated to a user ID, both of the processors each being connectable with an operating terminal; and
an allocation manager that refers, upon abnormality information from a processor, to an allocation table by use of the user ID of the abnormality information to specify a processor that is not allocated to the user ID, orders the processor that has been allocated and specified to store user data allocated to the user ID in a storage of the user information server, and orders the processor that has not been allocated but specified to acquire the user data stored in the storage of the user information server.

6. A management method for managing connection among a user information server, a plurality of processors, and a plurality of operating terminals connected via a network, comprising the steps of:
acquiring, with a board controller of a processor, performance information on the processor which comprises the board controller to judge whether or not the performance information exceeds a threshold thereby to transmit abnormality information of exceeding the threshold to the management server;
storing, with the management server, both information of processors each being allocated to a user ID and information of processors each being not allocated to a user ID, both of the processors each being connectable with an operating terminal; and
referring, with the management server, upon abnormality information from a processor, to an allocation table by use of the user ID of the abnormality information to specify a processor that is not allocated to the user ID, ordering the processor that has been allocated and specified to store user data allocated to the user ID in a storage of the user information server, and ordering the processor that has not been allocated but specified to acquire the user data stored in the storage of the user information server.
